(19) United States
(12) Patent Application Publication
(10) Pub. No.: US 2012/0203881 A1
(43) Pub. Date: Aug. 9, 2012

(54) COMPUTING SYSTEM, CONFIGURATION MANAGEMENT DEVICE, AND MANAGEMENT

(75) Inventor: Yoshinori SUTO, Kawasaki (JP)

(73) Assignee: FUJITSU LIMITED, Kawasaki-shi (JP)

(21) Appl. No.: 13/354,476

(22) Filed: Jan. 20, 2012

(30) Foreign Application Priority Data
Feb. 9, 2011 (JP) 2011-025790

(51) Int. Cl. G06F 15/173

(52) U.S. Cl. 709/223

(57) ABSTRACT

A computing system includes a node system configured to include each of a plurality of nodes coupled through paths processes received data and transmits data of a processing result to another node; and a configuration manager configured to include a node manager setting a first length of a path located close to an end point from which data is output in the node system to a second length greater than or equal to the first length, of a path located further away from the end point when paths coupling the nodes to one another are set, the node system processing data by using a network in which the plurality of nodes are coupled through paths set by the node manager.

### CROSS-REFERENCE TO RELATED APPLICATION

This application is based upon and claims the benefit of priority of the prior Japanese Patent Application No. 2011-025790, filed on Feb. 9, 2011, the entire contents of which are incorporated herein by reference.

### FIELD

The embodiments discussed herein are related to a computing system, a configuration management device, and a management program recording medium.

### BACKGROUND

In recent years, there have been widely used parallel computer systems in which a plurality of nodes including processors such as grid computers or the like are coupled. In addition, in such a parallel computer system in which a great number of nodes are coupled, for example, as a method for establishing synchronization between nodes and performing communication between nodes, there has been known a system utilizing a butterfly network model so as to realize barrier synchronization or a collective communication operation.

In the barrier synchronization, a point establishing synchronization, namely, a barrier point, is set in accordance with the progression stage of the processing of a process, and when the processing of a process has reached a barrier point, a process performing barrier synchronization temporarily halts the processing of a process, thereby waiting for the progression of the processing of a process in another node. When all processes performing barrier synchronization and subjected to parallel processing have reached barrier points, the process performing barrier synchronization terminates a waiting state and resumes the halted processing. Accordingly, it is possible to synchronize the parallel processing between a plurality of processes subjected to parallel processing between a plurality of nodes.

This butterfly network model is a network model recursively configured. When system processing is performed in which such a great number of nodes are coupled using a butterfly network, first, input data are processed at an initial stage, and communication is established between two nodes adjacent to each other to exchange data obtained owing to processing. Next, data obtained owing to the processing operations performed in these nodes are further exchanged with another node on the basis of communication, and each node repeats the processing of data and the exchange of data based on communication with another node, the data being obtained owing to the processing. In addition, finally, the processing results of all nodes are collected at each node, thereby executing a requested processing.

However, in a computer system in which a large number of nodes are coupled using the above-mentioned butterfly network model or the like, the data of a processing result is transferred through a path establishing connection between individual nodes, with respect to each stage. Therefore, since a large amount of data communication is performed within a network, there occurs a problem that, in some cases, communication congestion and the loss of processing calculation time occur on the basis of the increase of a data transfer amount between nodes.

Related techniques are also described in Japanese Laid-open Patent Publication No. 7-212360, Japanese Laid-open Patent Publication No. 2007-156850, and Japanese Laid-open Patent Publication No. 9-106389.

### SUMMARY

According to an aspect of an invention, a computing system includes a node system configured to include each of a plurality of nodes coupled through paths processes received data and transmits data of a processing result to another node; and a configuration manager configured to include a node manager setting a first length of a path located close to an end point from which data is output in the node system to a second length grater than or equal to the first length, of a path located further away from the end point when paths coupling the nodes to one another are set, the node system processing data by using a network in which the plurality of nodes are coupled through paths set by the node manager.

This configuration management device sets paths of a node system in which each of a plurality of nodes coupled through paths processes received data and transmits data of a processing result to another node, thereby processing data. In this configuration management device, a node manager sets the length of a path located close to an end point from which data is output in the node system to a length less than or equal to the length of a path located further away from the end point when paths coupling the nodes to one another are set.

This configuration management program recording medium records a computer-readable configuration management program used for causing a computer to execute setting the length of a path located close to an end point from which data is output in a node system to a length less than or equal to the length of a path located further away from the end point, when there are set paths of the node system in which each of a plurality of nodes coupled through paths processes received data and transmits data of a processing result to another node, thereby processing data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration management device of a first embodiment.

FIG. 2 illustrates a system configuration of a second embodiment.

FIG. 3 illustrates a hardware configuration of a server of the second embodiment.

FIG. 4 illustrates a hardware configuration of a node of the second embodiment.

FIG. 5 is a block diagram illustrating a function of the server of the second embodiment.

FIG. 6 illustrates a network of nodes of the second embodiment.

FIG. 7 illustrates the appearance of processing when a network is configured in a case in which the number of ranks in the second embodiment is a power of 2.

FIG. 8 illustrates the appearance of processing when a network is configured in a case in which the number of ranks in the second embodiment is a power of 2.

FIG. 9 illustrates the appearance of processing when a network is configured in a case in which the number of ranks in the second embodiment is a power of 2.

FIG. 10 illustrates the appearance of processing when a network is configured in a case in which the number of ranks in the second embodiment is a power of 2.

FIG. 11 illustrates the appearance of processing when a network is configured in a case in which the number of ranks in the second embodiment is a power of 2.

FIG. 12 illustrates the appearance of processing when a network is configured in a case in which the number of ranks in the second embodiment is not a power of 2.

FIG. 13 illustrates the appearance of processing when a network is configured in a case in which the number of ranks in the second embodiment is not a power of 2.

FIG. 14 illustrates the appearance of processing when a network is configured in a case in which the number of ranks in the second embodiment is not a power of 2.

FIG. 15 illustrates the appearance of processing when a network is configured in a case in which the number of ranks in the second embodiment is not a power of 2.

FIG. 16 illustrates the appearance of processing when a network is configured in a case in which the number of ranks in the second embodiment is not a power of 2.

FIG. 17 illustrates the appearance of processing when a network is configured in a case in which the number of ranks in the second embodiment is not a power of 2.

FIG. 18 illustrates the appearance of processing when a network is configured in a case in which the number of ranks in the second embodiment is not a power of 2.

FIG. 19 illustrates a method of network configuration processing in the second embodiment.

FIG. 20 illustrates a method of network configuration processing in the second embodiment.

FIG. 21 illustrates a method of network configuration processing in the second embodiment.

FIG. 22 illustrates a method of first number-of-used-gates calculation processing in the second embodiment.

FIG. 23 illustrates a method of second number-of-used-gates calculation processing in the second embodiment.

FIG. 24 illustrates a method of gate connection destination setting processing in the second embodiment.

FIG. 25 illustrates a method of final gate connection destination setting processing in the second embodiment.

FIG. 26 illustrates a method of initial gate connection destination setting processing in the second embodiment.

### DESCRIPTION OF EMBODIMENTS

Hereinafter, embodiments will be described with reference to drawings.

### First Embodiment

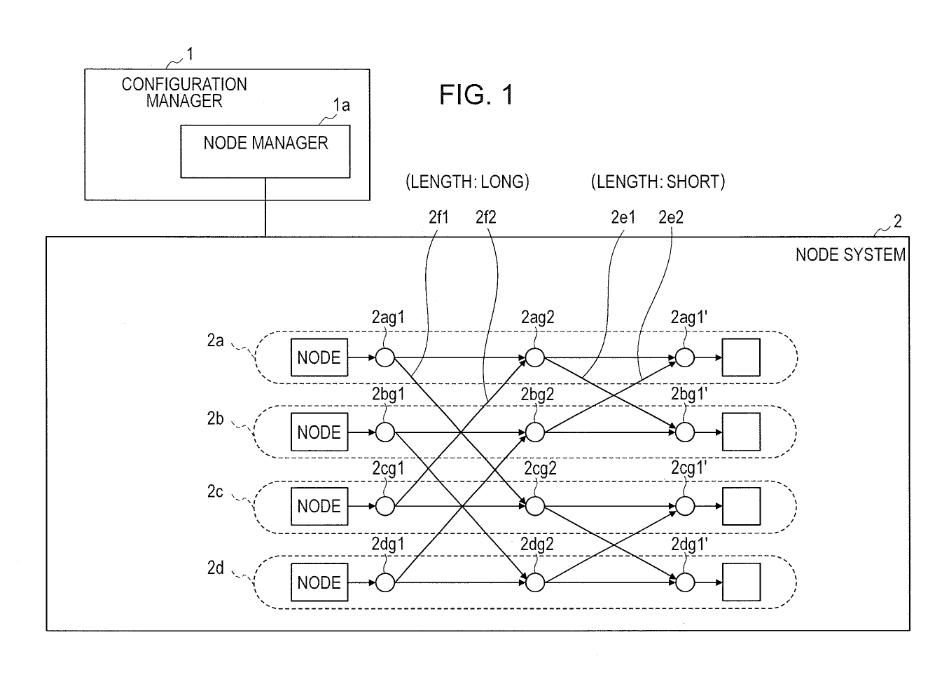

FIG. 1 illustrates a configuration management device of a first embodiment. A configuration manager 1 of the present embodiment includes a node manager 1a. In addition, the configuration manager 1 is coupled to a node system 2 using a communication line such as a local area network (LAN) or the like. In addition, the node system 2 includes a plurality of nodes 2a, 2b, 2c, and 2d in which a path establishing connection between one node and another can be set.

On the basis of the node manager 1a, the configuration manager 1 sets a path coupling nodes to one another in the node system 2 processing data. In accordance with the path set by the configuration manager 1, transmission/reception is performed between nodes, and hence processing is executed in the node system 2.

The node manager 1a sets paths coupling nodes to one another in the node system 2, thereby configuring a network. In this case, the node manager 1a sets the length of a path 2e to a length less than or equal to the length of a path 2f, the path 2e being located close to an end point from which the data of a processing result is output in the node system 2, the path 2f being located farther away from the end point.

As in the present embodiment, in a computing system in which nodes 2a to 2d utilizing a network model are coupled to one another using paths set by the node manager 1a and processing is performed with the nodes 2a to 2d exchanging one another's processing results, as a result through the processing of each node, there is a tendency that data transfer amounts between nodes in an initial stage are small and data transfer amounts between nodes gradually increase with progression in the stages of processing, in many cases. In addition, there is a tendency that, in many cases, data transfer amounts between nodes become maxima in communication performed in a final stage located closest to the end point from which data is output. On the basis of these, the node manager 1a sets, to a short length, the length of the path 2e located close to the end point from which the data of a processing result is output in the node system 2, thereby improving efficiency in the processing of the computing system.

Each of the nodes 2a to 2d transmits, to another node, the data of a processing result that is the result of processing such as an operation or the like performed on received data, and hence the node system 2 processes data in response to a request from a client device not illustrated. Each of the nodes 2a to 2d includes a processor processing data, processes received data, and transmits the data of a processing result to another node.

Here, FIG. 1 illustrates the nodes 2a to 2d performing processing while transmitting and receiving data to and from one another in accordance with set paths. Gates 2ag1 and 2ag2 indicate points serving as separators when processing to be executed in the node 2a is divided. In addition, a gate 2ag1′ is a dummy gate aggregating the data of a processing result obtained by processing in each node in the node system 2. In the same way, each of gates 2bg1 and 2bg2 indicates the separating point of a stage in processing to be executed in the node 2b, each of gates 2cg1 and 2cg2 indicates the separating point of a stage in processing to be executed in the node 2c, and each of gates 2dg1 and 2dg2 indicates the separating point of a stage in processing to be executed in the node 2d. A gate 2ag1′, a gate 2bg1′, a gate 2cg1′, and a gate 2dg1′ are dummy gates. In addition, arrows coupling individual gates to one another are paths (for example, paths 2e1, 2e2, 2f1, and 2f2) performing the transmission/reception of data between gates. Each node transmits data in a direction indicated by the arrow of a path, in each gate. A path is set by the node manager 1a, and data is transmitted and received every time each node has completed processing in each gate.

In FIG. 1, it is assumed that the progression of processing to be executed in the nodes 2a to 2d is indicated so that the processing is sequentially shifted from a gate on a left side to a gate on a right side. When processing has been started in the nodes 2a to 2d and initial separated processing in the node 2a has been completed, the data of the result of the initial separated processing is transmitted by the node 2a from the gate 2ag1 to the gate 2cg2 in the node 2c through the path 2f1. In addition, the data of the processing result of initial separated processing that has been completed in the node 2c is transmitted by the node 2c from the gate 2cg1 to the gate 2ag2 in the node 2a through the path 2f2. In the gates 2bg1 and 2dg1, the same processing is also executed with respect to initial processing separated by each node, and the data of a processing result is transmitted and received through a path coupled to each of the gates 2bg1 and 2dg1.

Here, in a path coupling a same node to the same node, actually, the transmission/reception of the data of a processing result between nodes is not performed, the data of a processing result is held in a node that has executed processing, and this means that the data is used for processing in a subsequent stage in the corresponding node. Next, when processing for the data of the result of the initial separated processing in the gate 2ag1 in the node 2a and the data of the result of the initial separated processing transmitted and received through the path 2f2 from the gate 2cg1, which is subsequent separated processing, has been completed by the node 2a, the data of the processing result of the subsequent separated processing is transmitted by the node 2a to the gate 2bg1′ in the node 2b adjacent to the node 2a through the path 2e1.

In addition, the data of the processing result of subsequent separated processing that has been completed in the node 2b is transmitted by the node 2b to the gate 2ag1′ in the node 2a adjacent to the node 2b through the path 2e2. In the gates 2cg2 and 2dg2, the same processing is also executed with respect to initial processing separated by each node, and the data of a processing result is transmitted and received through a path coupled to each of the gates 2cg2 and 2dg2.

Next, in the gates 2ag1′ to 2dg1′ that are dummy gates, the nodes 2a to 2d transmit, to the request source of processing such as a client device or the like, aggregation results obtained by aggregating data transmitted from the gates 2ag2 to 2dg2, or processing results generated on the basis of the corresponding aggregation results, through a communication line.

In addition, while, in the present embodiment, the node system 2 includes the four nodes 2a to 2d, the node system 2 may include an arbitrary number of nodes without being limited to the four nodes. In addition, while the nodes 2a to 2d include the two gates 2ag1 and 2ag2, the two gates 2bg1 and 2bg2, the two gates 2cg1 and 2cg2, and the two gates 2dg1 and 2dg2, respectively, each of the nodes 2a to 2d may include an arbitrary number of nodes without being limited to the two gates. In addition, the node system 2 may also configure a network without using part of nodes from among nodes included in the node system 2 itself and with using an arbitrary number of nodes, and perform the processing of data.

As described above, in the present embodiment, with respect to the configuration of the network of the node system 2, the length of the path 2e located close to the end point is set to a length shorter than the length of another path, for example, in such a way that the path 2e to a final stage is set to a path to an adjacent node. Therefore, a data transfer amount per length of a path within the network of the node system 2 is reduced, the efficiency of the transfer of data within the network is improved to reduce a communication amount, and hence it is possible to suppress the occurrence of communication congestion and the occurrence of the loss of processing time.

### Second Embodiment

Next, with respect to a function for improving the efficiency of the transfer of data within the network, included in the configuration manager 1 illustrated in FIG. 1, an embodiment applied to a server 100 will be described as a second embodiment.

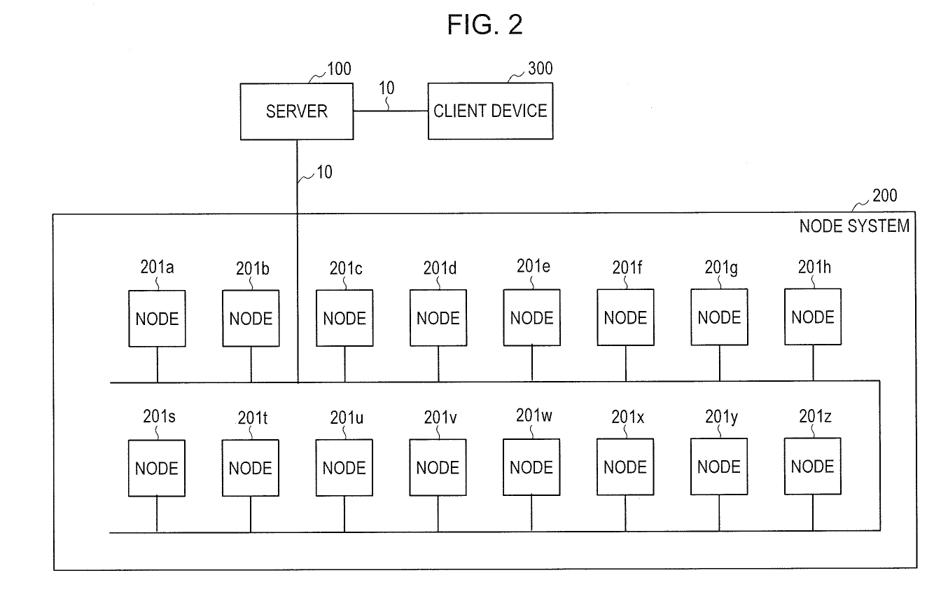

FIG. 2 illustrates the system configuration of the second embodiment. A computing system illustrated in FIG. 2 includes a server 100, a node system 200, and a client device 300. The server 100 and the node system 200 are coupled to each other so as to be able to communicate with each other and the server 100 and the client device 300 are coupled to each other so as to be able to communicate with each other, through a network 10 such as a LAN or the like.

The server 100 divides a request for processing from the client device 300 into jobs, and transmits the jobs to the node system 200, and when having received the processing results of the jobs from the node system 200, the server 100 transmits the processing results to the client device 300.

The node system 200 includes nodes 201a, 201b, 201c, 201d, 201e, 201f, 201g, 201h, 201s, 202t, 201u, 201v, 201w, 201x, 201y, and 201z that process distributed jobs. The nodes 201a to 201z exchange the results of the distributed jobs with one another in accordance with a network model configured by the server 100, and aggregate and transmit processing results to the server 100.

The node system 200 includes a plurality of nodes, implements therein a message passing interface (MPI) that is a library supporting memory-distributed parallel computation, configures a network utilizing an arbitrary number of nodes on the basis of the instruction of the server 100, and executes requested processing in the configured network. In the example in FIG. 2, the node system 200 includes sixteen nodes 201a to 201z. By communicating with one another through the network 10, the nodes 201a to 201z perform barrier synchronization, thereby executing a parallel operation.

Here, the barrier synchronization will be briefly described. It is assumed that processing executed in the node system 200 in the computing system of the present embodiment is divided into a plurality of stages and executed with respect to each stage divided in each node. In the barrier synchronization, when each stage of processing has been completed and the processing has reached a point (barrier point) at which synchronization is generated, each node executing the barrier synchronization halts the processing of itself.

Namely, when the stage of processing has finished and the processing has reached the barrier point, each node waits for processing due to another node to reach a barrier point. When processing operations due to all nodes in the node system 200 performing barrier synchronization have reached barrier points (namely, barrier synchronization has been established), each node starts a subsequent stage of processing. Accordingly, it is possible to synchronize parallel processing between a plurality of nodes subjecting processes to parallel processing, with respect to each stage.

As one algorithm for realizing such barrier synchronization, there is butterfly computation. Hereinafter, the butterfly computation will be simply referred to as “butterfly”. In the butterfly, processing is divided into a plurality of stages, and the communication of a signal with another node is performed with respect to each stage.

The client device 300 is an information processing device operated by a user. The client device 300 transmits, to the server 100, a request to be processed in the node system 200 through the network 10, and receives a processing result transmitted from the server 100 through the network 10.

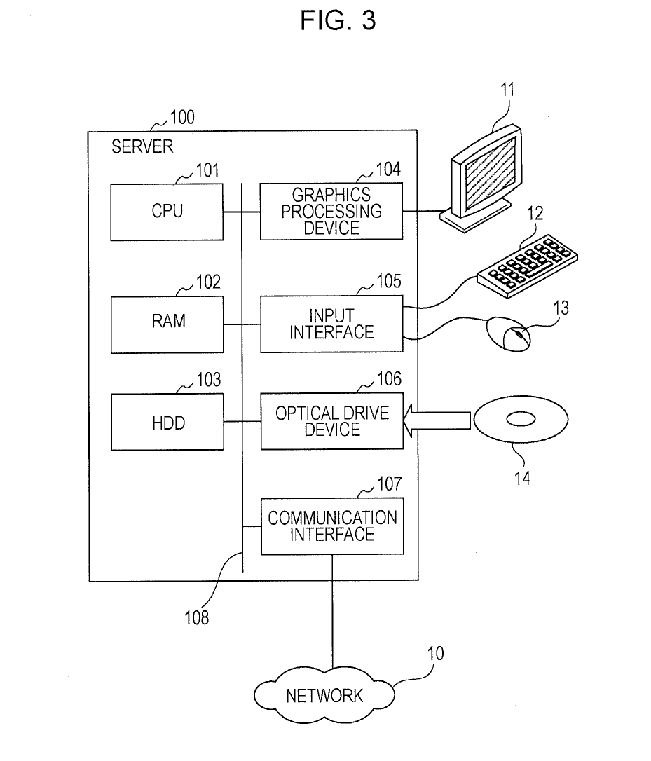

FIG. 3 illustrates the hardware configuration of a server of the second embodiment. The whole device of the server 100 is controlled by a central processing unit (CPU) 101. A random access memory (RAM) 102 and a plurality of peripheral devices are coupled to the CPU 101 through a bus 108.

The RAM 102 is used as the main storage device of the server 100. In the RAM 102, the program of an operating system (OS) caused to be executed by the CPU 101 and at least part of an application program are temporarily stored. In addition, in the RAM 102, various kinds of data necessary for processing performed by the CPU 101 are stored.

Peripheral devices coupled to the bus 108 include a hard disk drive (HDD) 103, a graphics processing device 104, an input interface 105, an optical drive device 106, and a communication interface 107.

The HDD 103 magnetically writes and reads data to and from an internal disk. The HDD 103 is used as the secondary storage device of the server 100. In the HDD 103, the program of an OS, an application program, and various kinds of data are stored. In addition, as the secondary storage device, a semiconductor storage device such as a flash memory or the like may also be used.

A monitor 11 is coupled to the graphics processing device 104. The graphics processing device 104 causes an image to be displayed on the screen of the monitor 11, in accordance with an instruction from the CPU 101. A liquid crystal display device using a liquid crystal display (LCD) or the like serves as the monitor 11.

A keyboard 12 and a mouse 13 are coupled to the input interface 105. The input interface 105 transmits, to the CPU 101, a signal sent from the keyboard 12 or the mouse 13. In addition, the mouse 13 is an example of a pointing device, and another pointing device may also be used. Examples of the other pointing device include a touch panel, a tablet, a touch-pad, and a trackball.

Using laser light or the like, the optical drive device 106 reads data recorded in an optical disk 14. The optical disk 14 is a portable recording medium in which data is recorded so as to be readable owing to the reflection of light. Examples of the optical disk 14 include a digital versatile disc (DVD), a DVD-RAM, a compact disc read only memory (CD-ROM), and CD-R (Recordable)/RW (ReWritable).

The communication interface 107 is coupled to the network 10. The communication interface 107 transmits and receives data to and from another computer or a communication device through the network 10.

In addition, while the hardware configuration of the server 100 is illustrated in FIG. 3, the client device 300 also has the same hardware configuration.

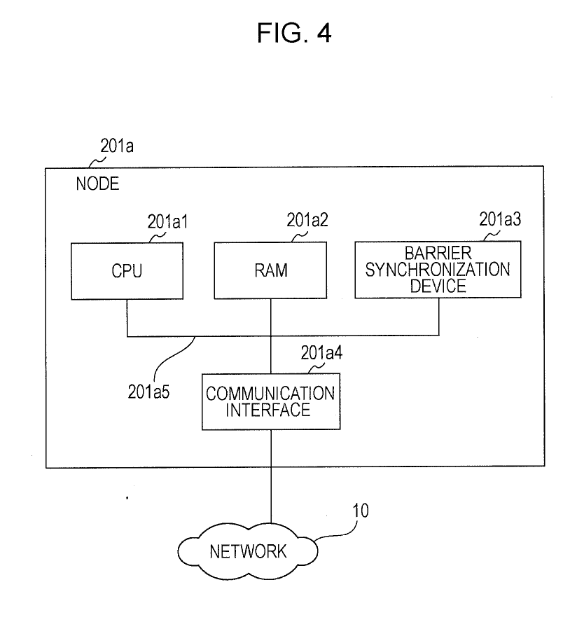

FIG. 4 illustrates the hardware configuration of a node of the second embodiment. A node 201a of the present embodiment includes a CPU 201a1, a RAM 201a2, a barrier synchronization device 201a3, and a communication interface 201a4. The CPU 201a1 is coupled to the RAM 201a2, the barrier synchronization device 201a3, and the communication interface 201a4 through a bus 201a5.

The CPU 201a1 controls the entirety of the node 201a. In addition, the CPU 201a1 transmits and receives necessary data to and from the RAM 201a2, the barrier synchronization device 201a3, and the communication interface 201a4 through the bus 201a5.

The CPU 201a1 transmits a signal of reaching a barrier point to the barrier synchronization device 201a3 through the bus 201a5, and receives a signal of the establishment of barrier synchronization from the barrier synchronization device 201a3. Accordingly, on the basis of the configuration of the network set by the server 100, the CPU 201a1 sets, in the barrier synchronization device 201a3, the destination of the barrier synchronization device 201a3 in a subsequent stage, which is the transmission destination of a synchronization signal.

In addition, the CPU 201a1 transmits and receives necessary data to and from the RAM 201a2 through the bus 201a5. Accordingly, the CPU 201a1 writes data in the RAM 201a2, and the CPU 201a1 reads out data from the RAM 201a2. For example, this data is the data of a job the processing of which is requested by the client device 300.

The RAM 201a2 is used as the main storage device of the node 201a. In the RAM 201a2, the program of an OS caused to be executed by the CPU 201a1 and at least part of an application program are temporarily stored. In addition, in the RAM 201a2, various kinds of data necessary for processing performed by the CPU 201a1 are stored.

Owing to the setting of the transmission destination of the synchronization signal, performed by the CPU 201a1, the barrier synchronization device 201a3 performs the barrier synchronization on the basis of communication with the barrier synchronization device 201a3 of another node, through the network 10.

The communication interface 201a4 outputs data and control signals to the server 100 and other nodes (nodes 201b to 201z) through the network 10, and receives data and control signals transmitted from the server 100 and other nodes through the network 10.

In addition, while the hardware configuration of the node 201a is illustrated in FIG. 4, the nodes 201b to 201z also include the same hardware configuration and the same function, and hence the descriptions thereof will be omitted.

According to the above-mentioned hardware configuration, it is possible to realize the processing function of the present embodiment.

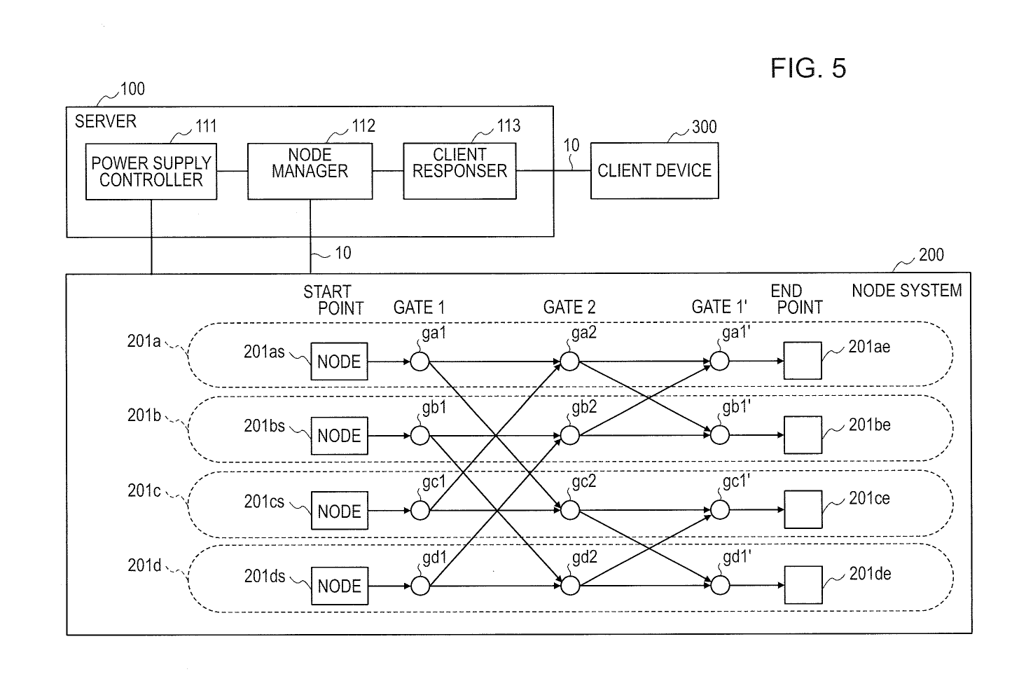

FIG. 5 is a block diagram illustrating the function of a server of the second embodiment. The server 100 of the present embodiment includes a power supply controller 111, a node manager 112, and a client responser 113. The node system 200 includes nodes 201a, 201b, 201c, and 201d, illustrated, and nodes 201e, 201f, 201g, 201f, 201g, 201h, 201s, 201t, 201u, 201v, 201w, 201x, 201y, and 201z, not illustrated. The node manager 112 is coupled to the nodes 201a to 201z through the network 10. The client responser 113 is coupled to the client device 300 through the network 10. In addition, the nodes 201a to 201z are capable of setting paths coupling the nodes 201a to 201z to one another.

The server 100 sets paths coupling nodes in the node system 200 processing data to one another.

The power supply controller 111 supplies electric power used for operation to the node system 200 and the nodes 201a to 201z.

The node manager 112 sets paths coupling nodes in the node system 200 to one another, and configures a network. In this case, with respect to the configuration of the network of the node system 200, the node manager 112 sets the length of a path located close to an end point from which the data of a processing result is output in the node system 200 to a length less than or equal to the length of a path located further away from the end point, for example, in such a way that a path to a final stage is set to a path to an adjacent node.

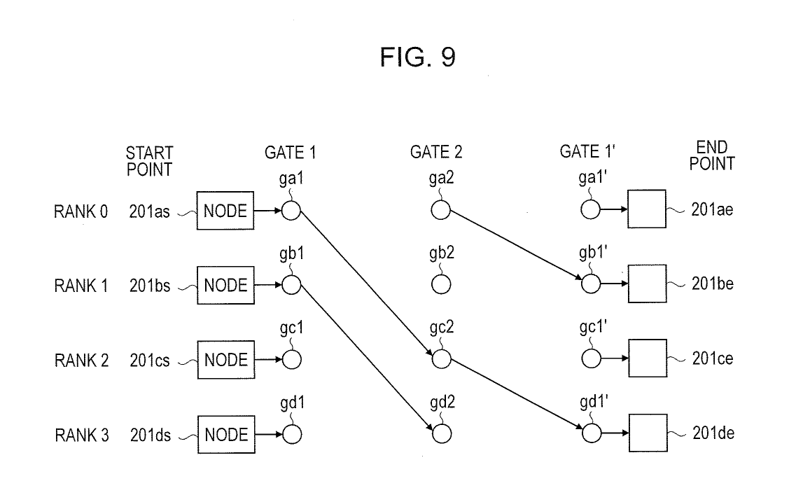

In addition, with respect to paths in the node system 200, the node manager 112 sets the length of a path located closer to the end point from which the data of a processing result is output to a shorter length, and sets the length of a path located further away from the end point to a longer length. For details, the length of a path is defined using the number of transfer hops described later in FIG. 9. In addition, while not being limited to this example, a physical path length may also be used as the length of a path, and artificially assigned weighting may also be used.

The client responser 113 transmits, to the node system 200, a request for processing from the client device 300 and the data of a processing target, and receives a processing result transmitted from the node system 200 to transmit the processing result to the client.

In the computing system of the present embodiment, processing is separated into a plurality of stages and advanced, the plural nodes 201a to 201z each of which includes a processor, utilizing the butterfly network model, are coupled through paths, and the nodes 201a to 201z perform processing with exchanging one another's processing results. In such a computing system, in processing performed in each of the nodes 201a to 201z, there is a tendency that a data transfer amount between nodes in an initial stage is small and a data transfer amount between nodes gradually increases with progression in stages, in many cases.

Namely, in communication performed in a final stage closest to an end point from which data is output, there is a tendency that a data transfer amount between nodes becomes the largest in many cases. On the basis of this, the node manager 112 sets, to a short length, the length of a path located close to an end point from which the data of a processing result is output in the node system 200, thereby improving efficiency in the processing of the computing system.

Each of the nodes 201a to 201z processes received data and transmits the data of a processing result to another node, and hence the node system 200 processes data in accordance with a request for processing from the client device 300. Each of the nodes 201a to 201z includes a CPU (for example, a CPU 201a1) as a processor processing data, and processes received data to transmit the data of a processing result to another node.

The network included in the node system 200 of the present embodiment is a butterfly network in which each node is recursively coupled through a path. In the node system 200, processing to be executed in each node is divided into processing operations of a plurality of stages, and the completion of processing in another node is waited for with respect to each of processing operations of stages divided owing to the barrier synchronization.

A gate 1 (gates ga1, gb1, gc1, and gd1) and a gate 2 (gates ga2, gb2, gc2, and gd2) indicate points serving as separators when processing to be executed in each of the nodes 201a to 201d is divided. A gate 1′ (gates ga1′, gb1′, gc1′, and gd1′) is a dummy gate aggregating the data of a processing result obtained by processing in each of the nodes 201a to 201d node in node system 200.

In addition, arrows coupling individual gates to one another are paths performing the transmission/reception of data between gates. Each node transmits data in a direction indicated by the arrow of a path, in each gate. A path is set by the node manager 122, and data is transmitted and received every time each node has completed processing in each gate. In the present embodiment, a gate functions as the above-mentioned barrier point.

In FIG. 5, it is assumed that the progression of processing to be executed in the nodes 201a to 201d is indicated so that the processing is sequentially shifted from a gate on a left side to a gate on a right side. When processing has been started in the nodes 201a to 201d and initial separated processing in the node 201a has been completed, the data of the result of the initial separated processing is transmitted by the node 201a from the gate ga1 to the gate gc2 in the node 201c through a path.

In addition, the data of the processing result of initial separated processing that has been completed in the node 201c is transmitted by the node 201c from the gate gc1 to the gate ga2 in the node 201a through a path. In the nodes 201b and 201c, the same processing is also executed in the gates gb1 and gd1 with respect to initial separated processing, and the data of a processing result is transmitted and received through a path coupled to each of the gates gb1 and gd1.

Here, in a path coupling a same node to the same node, actually, the transmission/reception of the data of a processing result between nodes is not performed, the data of a processing result is held in a node that has executed processing, and this means that the data is used for processing in a subsequent stage in the corresponding node.

Next, when processing for the data of the result of the initial separated processing in the gate ga1 in the node 201a and the data of the result of the initial separated processing transmitted and received through a path from the gate gc1, which is subsequent separated processing, has been completed by the node 201a, the data of the processing result of the subsequent separated processing is transmitted by the node 201a to the gate gb1′ in the node 201b through a path.

In addition, the data of the processing result of subsequent separated processing that has been completed in the gate gb1 in the node 201b is transmitted by the node 201b to the gate ga1′ in the node 201a through a path. In the nodes 201c and 201d, the same processing is also executed in the gates gc2 and gd2 with respect to initial processing separated by each node, and the data of a processing result is transmitted and received through a path coupled to each of the gates gc2 and gd2.

Next, in the gates ga1′ to gd1′ that are dummy gates, the nodes 201a to 201d transmit, to the client device 300 that is the request source of processing, aggregation results obtained by aggregating data transmitted from the gates ga2 to gd2, or processing results generated on the basis of the corresponding aggregation results, through the network 10.

In addition, in the present embodiment, while each node is coupled through the butterfly network in the node system 200, the connection of nodes is not limited to this example, and each node may also be coupled through a path of a network having an arbitrary configuration. For example, in the node system 200, the network of paths coupling individual nodes may also be a three-dimensional torus. In addition, in the node system 200, the network of paths coupling individual nodes may also be a fat tree.

In addition, while, in the present embodiment, the node system 200 includes the 16 nodes 201a to 201z, the node system 200 may also include an arbitrary number of nodes without being limited to the 16 nodes. In addition, the node system 200 may also configure a network without using part of nodes from among nodes included in the node system 200 itself and with using an arbitrary number of nodes, and perform the processing of data.

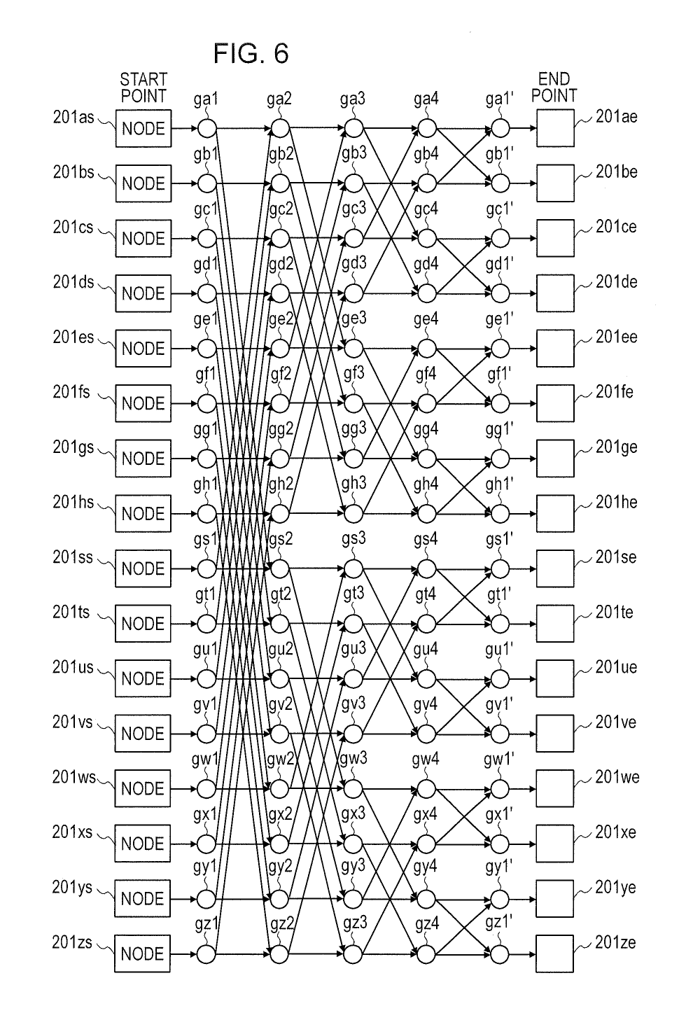

FIG. 6 illustrates the network of nodes of the second embodiment. In the present embodiment, using an arbitrary number of nodes in the node system 200 (for example, the 16 nodes 201a to 201z), the server 100 configures a network. In a computing system in the present embodiment, each node repeats processing data received in accordance with the configuration and transmitting the processed data to a subsequent node, thereby executing requested processing.

According to FIG. 6, an example will be illustrated when processing of four stages is executed using the 16 nodes 201a to 201z.

A start point 201as indicates the start point of a processing operation executed in the node 201a. A start point 201bs to a start point 201zs also indicate the start points of processing operations executed in the nodes 201b to 201z, respectively. An end point 201ae indicates the end point of the processing operation executed in the node 201a. An end point 201be to an end point 201ze also indicate the end points of processing operations executed in the nodes 201b to 201z, respectively.

In the node 201a, gates ga1 to ga4 are provided so as to synchronize the stages of the processing operation executed in the node 201a, and indicate points serving as separators of individual stages in the processing operation divided into a plurality of stages (four stages in FIG. 6). In addition, in the node 201a, a gate ga1′ is a dummy gate aggregating the data of a processing result obtained by processing in each node in the node 201a.

In the same way, in the node 201b, gates gb1 to gb4 and a gate gb1′ are provided. In the node 201c, gates gc1 to gc4 and a gate gc1′ are provided. In the node 201d, gates gd1 to gd4 and a gate gd1′ are provided. In the node 201e, gates ge1 to ge4 and a gate ge1′ are provided. In the node 201f, gates gf1 to gf4 and a gate gf1′ are provided. In the node 201g, gates gg1 to gg4 and a gate gg1′ are provided. In the node 201h, gates gh1 to gh4 and a gate gh1′ are provided. In the node 201s, gates gs1 to gs4 and a gate gs1′ are provided. In the node 201t, gates gt1 to gt4 and a gate gt1′ are provided. In the node 201u, gates gu1 to gu4 and a gate gu1′ are provided. In the node 201v, gates gv1 to gv4 and a gate gv1′ are provided. In the node 201w, gates gw1 to gw4 and a gate gw1′ are provided. In the node 201x, gates gx1 to gx4 and a gate gx1′ are provided. In the node 201y, gates gy1 to gy4 and a gate gy1′ are provided. In the node 201z, gates gz1 to gz4 and a gate gz1′ are provided.

In individual gates, the nodes 201a to 201z wait until the stages of the processing operations of gates, the gates being arranged in a longitudinal direction and targets for the establishment of synchronization (for example, in the case of the gate ga1, targets for the establishment of synchronization are the gates gb1, . . . , and gz1), have finished in the nodes 201a to 201z, and when the processing operations of gates where synchronization is established have finished, the nodes 201a to 201z start the processing operations of a subsequent stage. Namely, when the processing operations of gates where synchronization is established in the nodes 201a to 201z have finished, the nodes 201a to 201z advance processing operations to subsequent gates (for example, the gates ga2, . . . , and gz2, respectively).

When the stages of the processing operations are advanced in such a way as described above, and after that, processing operations of the stages of the gates ga4, . . . , and gz4 have been completed, the nodes 201a to 201z proceed to the gates ga1′, . . . , and gz1′ that are dummy gates, respectively, and aggregate the processing results of nodes coupled through paths. When the aggregation of processed data has finished in each of the gates ga1′, . . . , and gz1′ in all nodes, the nodes 201a to 201d transmit received data to the server 100, in the end points 201ae, . . . , and 201ze. The server 100 collects data transmitted from each node, and transmits the final processing result of the requested processing to the client device 300.

In addition, each of arrows in FIG. 6 indicates the path of the data of a processing result due to a node in each stage, the path being set by the server 100. For example, arrows are indicated from the gate ga1 toward the gate gs2 and the gate ga2. An arrow headed from the gate ga1 to the gate gs2 indicates a path through which data processed in the gate ga1 is transmitted to the gate gs2. An arrow headed from the gate ga1 to the gate ga2 indicates a path through which data processed in the gate ga1 is also transmitted to the gate ga2.

Here, in a path coupling a same node to the same node, actually, the transmission/reception of the data of a processing result between nodes is not performed, the data of a processing result is held in a node that has executed processing, and this means that the data is used for processing in a subsequent stage in the corresponding node. Namely, the arrow headed from the gate ga1 to the gate ga2 is a path coupling the node 201as to the node 201as that is the same node.

Therefore, the transmission/reception of data is nor performed in the path from the gate ga1 to the gate ga2, and the data of the processing result of the gate ga1 is held in the node 201as with being transmitted to the node 201ss. The node 201as executes processing in the gate ga2 using data transmitted from the node 201ss and the data processed in the gate ga1 and held. While description is omitted, processing is also performed in the same way with respect to the other nodes.

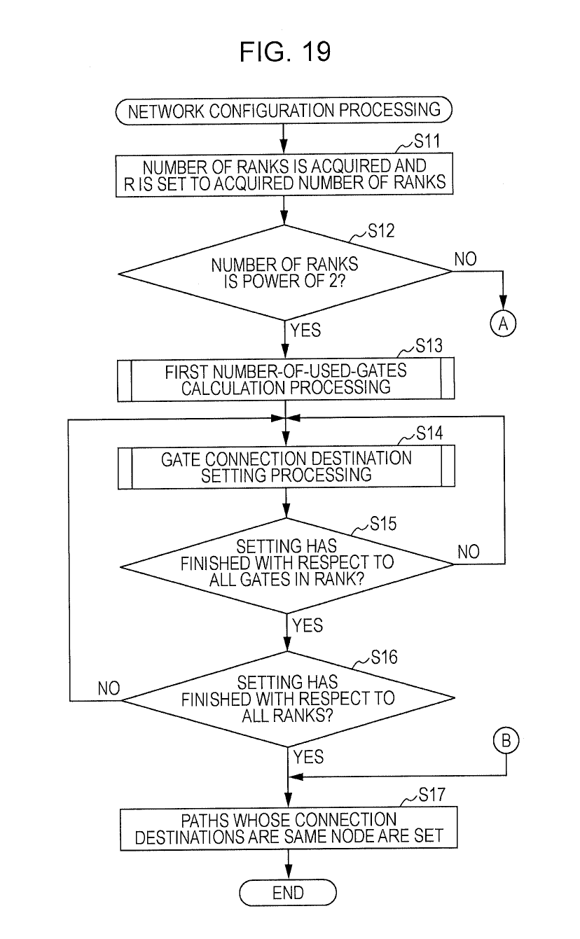

Next, the appearance of processing will be described in which the server 100 of the present embodiment configures the network of each node in the node system 200. In the present embodiment, in processing operations due to a network configuration, described later in FIG. 19 to FIG. 21, the server 100 sets paths between gates in nodes in the node system 200 on the basis of the number of ranks (the number of nodes used for processing), thereby configuring the network of the node system 200.

At this time, the configuration method of the network differs depending on a case in which the number of ranks is a power of 2 (when “n” is an arbitrary natural number, the number can be expressed by “2ⁿ”) and a case in which the number of ranks is not a power of 2. Hereinafter, processing performed when a network is configured in a case in which the number of ranks of the present embodiment is a power of 2 and processing performed when a network is configured in a case in which the number of ranks is not a power of 2 will be described.

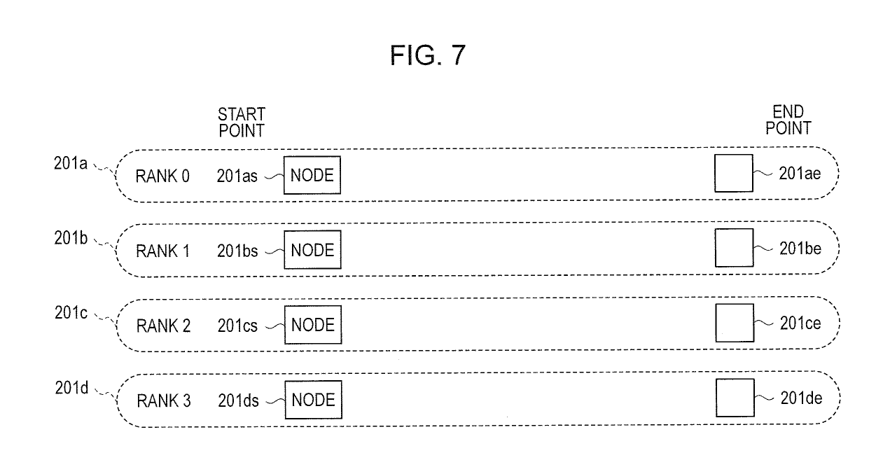

FIG. 7 to FIG. 11 are diagrams illustrating the appearance of processing when a network is configured in a case in which the number of ranks in the second embodiment is a power of 2.

As illustrated in FIG. 7, first, the server 100 of the present embodiment acquires the number of ranks of the network to be configured, and sets the number of ranks of the network to be configured to the acquired number. In FIG. 7, it is assumed that the server 100 has acquired “4” as the number of ranks.

On the basis of this, as illustrated in FIG. 7, four nodes of ranks “0”, “1”, “2”, and “3” (nodes 201a, 201b, 201c, and 201d, respectively) are set by the server 100. In addition, as illustrated in FIG. 7, the start point 201as and the end point 201ae of the node 201a, the start point 201bs and the end point 201be of the node 201b, the start point 201cs and the end point 201ce of the node 201c, and the start point 201ds and the end point 201de of the node 201d are set by the server 100.

Next, the server 100 calculates a binary logarithm of the acquired number of ranks (when the number of ranks is “R”, log₂ R (truncated after the decimal point)), and sets the number of used gates to a result. When the number of ranks is 4 as described above, the number of used gates is log₂ R=log₂ 4=2.

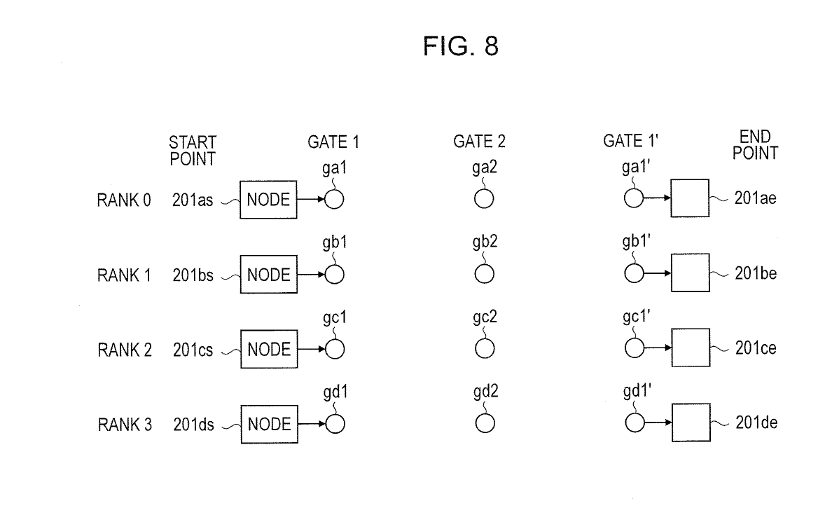

Accordingly, as illustrated in FIG. 8, the server 100 sets two gates (gates 1 and 2) and one dummy gate (gate 1′) in each node. In addition, it is assumed that the number of used gates does not include a dummy gate. Specifically, the server 100 sets gates ga1, ga2, and ga1′ in the node 201a. In the same way, the server 100 sets gates gb1, gb2, and gb1′ in the node 201b, sets gates gc1, gc2, and gc1′ in the node 201c, and sets gates gd1, gd2, and gd1′ in the node 201d.

Next, the server 100 sets a path that establishes connection between individual gates (for example, between the gate 1 and the gate 2 in each node and between the gate 2 and the gate 1′ in each node) and is a path of a direction in which a rank increases (a downward direction in FIG. 9). At this time, the server 100 sets a path so that the length of the path located closer to the end point of each node becomes shorter (the number of transfer hops is small) and the length of the path located further away from the end point (namely, located closer to a start point) becomes longer (the number of transfer hops is large).

When the number of ranks is “4” as described above, as illustrated in FIG. 9, the server 100 set paths so that the lengths of the paths located (on a right side in FIG. 9) close to the end points 201ae to 201de of the nodes 201a to 201d, respectively, become short and the lengths of the paths located (on a left side in FIG. 9) away from the end points 201ae to 201de of the nodes 201a to 201d (namely, located close to the start points 201as to 201ds), respectively, become long.

Here, it is assumed that the length of a path is defined on the basis of a difference between the values of the ranks of two gates coupled by the path (hereinafter, defined as the number of transfer hops). When there are two paths where the numbers of transfer hops thereof are different from each other, it is assumed that the length of one path the number of transfer hops of which is large is long and the length of the other path the number of transfer hops of which is small is short.

For example, in a path leading from the gate ga1 in the node 201a of a rank 0 to the gate gc2 in the node 201c of a rank 2, illustrated in FIG. 9, the number of transfer hops corresponds to the rank 2−the rank 0=2. In addition, in a path leading from the gate ga2 in the node 201a of the rank 0 to the gate gb1′ in the node 201b of a rank 1, the number of transfer hops corresponds to the rank 1−the rank 0=1.

Accordingly, it turns out that the path leading from the gate ga2 to the gate gb1′ and being located close to an end point is shorter than the path leading from the gate ga1 to the gate gc2 and being located away from the end point.

As for the setting of a path of a direction in which a rank between gates increases, performed by the server 100, specifically, in paths leading from the gate 2 to the gate 1′ and being located closest to the end point 201ae to 201de sides, a path is set that leads from the gate ga2 in the node 201a of the rank 0 to the gate gb1′ in the node 201b of the rank 1 whose rank increases by “1”, the number of transfer hops of the path being “1”. In addition, the server 100 sets a path that leads from the gate gc2 in the node 201c of the rank 2 to the gate gd1′ in the node 201d of the rank 3 whose rank increases by “1”, the number of transfer hops of the path being “1”.

In addition, in paths leading from the gate 1 to the gate 2 and located away from the end point 201ae to 201de sides compared with paths leading from the gate 2 to the gate 1′, the server 100 sets a path that leads from the gate ga1 in the node 201a of the rank 0 to the gate gc2 in the node 201c of the rank 2 whose rank increases by “2”, the number of transfer hops of the path being “2”.

In addition, the server 100 sets a path that leads from the gate gb1 in the node 201b of the rank 1 to the gate gd2 in the node 201d of the rank 3 whose rank increases by “2”, the number of transfer hops of the path being “2”.

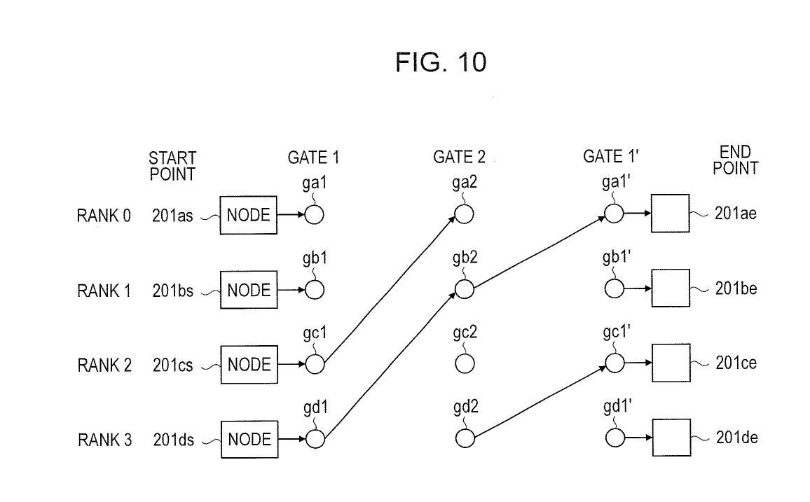

Next, the server 100 sets a path that establishes connection between individual gates and is a path of a direction in which a rank decreases (an upward direction in FIG. 10). At this time, in the same way as in FIG. 9, the server 100 sets a path so that the length of the path located closer to the end point of each node becomes shorter (the number of transfer hops is small) and the length of the path located further away from the end point becomes longer (the number of transfer hops is large).

As for the setting of a path of a direction in which a rank between gates decreases, performed by the server 100, specifically, in paths leading from the gate 2 to the gate 1′ and being located closest to the end point 201ae to 201de sides, a path is set that leads from the gate gb2 in the node 201b of the rank 1 to the gate ga1′ in the node 201a of the rank 0 whose rank decreases by “1”, the number of transfer hops of the path being “1”.

In addition, the server 100 sets a path that leads from the gate gd2 in the node 201d of the rank 3 to the gate gc1′ in the node 201c of the rank 2 whose rank decreases by “1”, the number of transfer hops of the path being “1”.

In addition, in paths leading from the gate 1 to the gate 2 and located away from the end point 201ae to 201de sides compared with paths leading from the gate 2 to the gate 1′, the server 100 sets a path that leads from the gate gc1 in the node 201c of the rank 2 to the gate ga2 in the node 201a of the rank 0 whose rank decreases by “2”, the number of transfer hops of the path being “2”.

In addition, the server 100 sets a path that leads from the gate gd1 in the node 201d of the rank 3 to the gate gb2 in the node 201b of the rank 1 whose rank decreases by “2”, the number of transfer hops of the path being “2”.

Next, the server 100 sets a path coupling gates belonging to a same node to each other. Specifically, in the node 201a, the server 100 sets a path coupling the gate ga1 to the gate ga2 and a path coupling the gate ga2 to the gate ga1′.

In addition, in the node 201b, the server 100 sets a path coupling the gate gb1 to the gate gb2 and a path coupling the gate gb2 to the gate gb1′. In addition, in the node 201c, the server 100 sets a path coupling the gate gc1 to the gate gc2 and a path coupling the gate gc2 to the gate gc1′. In addition, in the node 201d, the server 100 sets a path coupling the gate gd1 to the gate gd2 and a path coupling the gate gd2 to the gate gd1′.

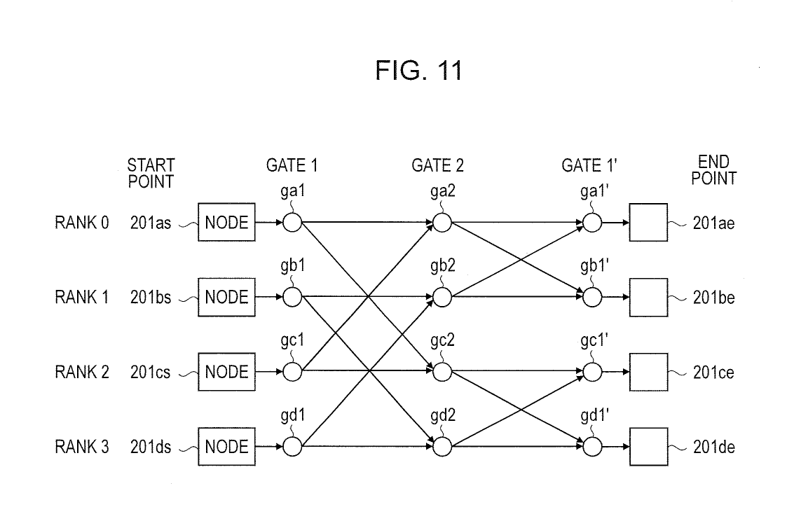

In addition, in FIG. 11, all the above-mentioned paths set by the server 100 are illustrated. As described above, in the present embodiment, when the number of ranks is a power of 2, the server 100 sets the numbers of transfer hops to small values with respect to paths located close to the end points 201ae to 201de, as for paths coupling gates in the nodes 201a to 201d.

In addition, the server 100 sets the numbers of transfer hops to large values with respect to paths located close to the start points 201as to 201ds. Accordingly, as for paths coupling gates in the nodes 201a to 201d, paths are set so that the lengths of the paths located closer to the end points 201ae to 201de become shorter (the numbers of transfer hops are small) and the lengths of the paths located closer to the start points 201as to 201ds become longer (the numbers of transfer hops are large).

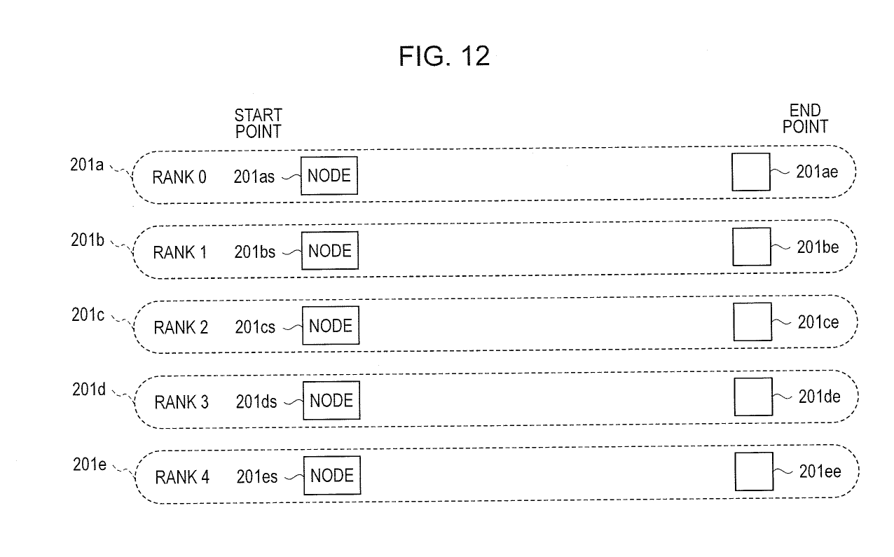

FIG. 12 to FIG. 18 are diagrams illustrating the appearance of processing when a network is configured in a case in which the number of ranks in the second embodiment is not a power of 2.

Here, as for the configuration of the network when the number of ranks is not a power of 2, when a maximum power of 2 not exceeding the number of ranks is defined as “Bmax” in the network in which the number of ranks is not a power of 2, the server 100 sets paths whose configuration is the same as the configuration of the network when the number of ranks is a power of 2, in nodes whose number corresponding to Bmax.

On the other hand, in remaining nodes obtained by excluding the nodes whose number corresponding to Bmax from the number of ranks, the server 100 sets a path headed from an initial gate in the remaining node so that the path is headed to any one of the nodes whose number corresponding to the above-mentioned Bmax.

In addition to this, the server 100 sets a path headed, to a final gate in the above-mentioned remaining node, from the second last node in a node in which the same path as when the above-mentioned number of ranks is a power of 2 is set.

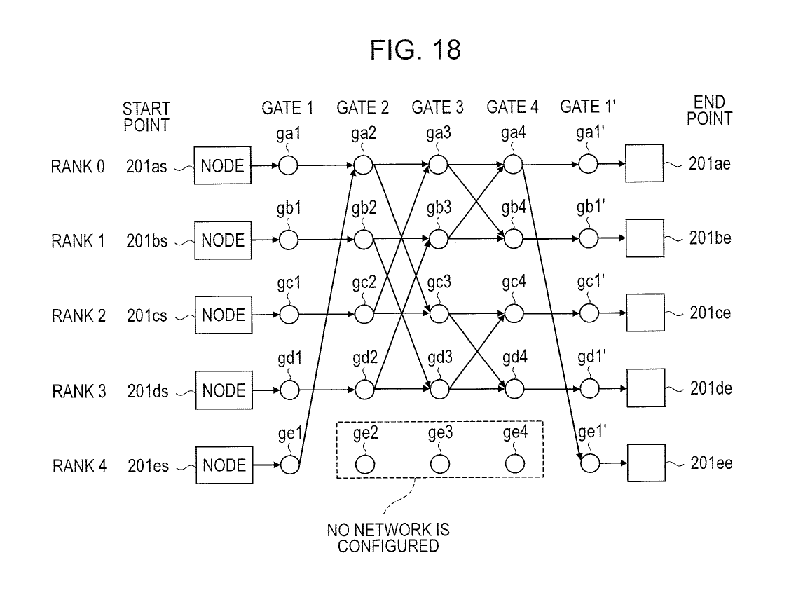

Specifically, as for four nodes of ranks 0, 1, 2, and 3, which are four nodes whose number corresponding to a maximum power of 2, “4”, not exceeding the number of ranks “5”, illustrated in FIG. 18, the server 100 sets paths headed from the gate 2 to the gate 3 and paths headed from the gate 3 to the gate 4 in the same way as the paths headed from the gate 1 to the gate 2 and the paths headed from the gate 2 to the gate 1′ in the ranks 0, 1, 2, and 3 illustrated in FIG. 11.

On the other hand, in the node of the rank 4, which is the remaining node, the server 100 sets a path headed from the gate gel of the rank 4 so that the path is headed to the gate gat of the rank 0. In addition to this, the server 100 sets a path headed from the gate ga4 of the rank 0, in which the same path as when the above-mentioned number of ranks is a power of 2 is set, to the gate ge1′ of the rank 4.

Hereinafter, in accordance with FIG. 12 to FIG. 18, an appearance will be specifically described when the network in the node system 200 is configured by the server 100 in a case in which the number of ranks is not a power of 2.

In the same way as when the number of ranks is a power of 2, as illustrated in FIG. 12, first, the server 100 of the present embodiment acquires the number of ranks of a network to be configured, and sets the number of ranks of a network to be configured to the acquired number. In FIG. 12, it is assumed that the server 100 has acquired “5” as the number of ranks.

On the basis of this, as illustrated in FIG. 12, five nodes of ranks “0”, “1”, “2”, “3”, and “4” (nodes 201a, 201b, 201c, 201d, and 201e, respectively) are set by the server 100. In addition, as illustrated in FIG. 12, the start point 201as and the end point 201ae of the node 201a, the start point 201bs and the end point 201be of the node 201b, the start point 201cs and the end point 201ce of the node 201c, the start point 201ds and the end point 201de of the node 201d, and the start point 201es and the end point 201ee of the node 201e are set by the server 100.

Next, the server 100 calculates a binary logarithm of the acquired number of ranks (truncated after the decimal point), adds “2” to the rounded binary logarithm, and sets the number of used gates to a result. When the number of ranks is 5 as described above, the number of used gates is log₂ R=log₂ 5≈2.3219 . . . , and furthermore, when, after the binary logarithm is truncated after the decimal point, 2 is added to the rounded binary logarithm, the number of used gates turns out to be “4”.

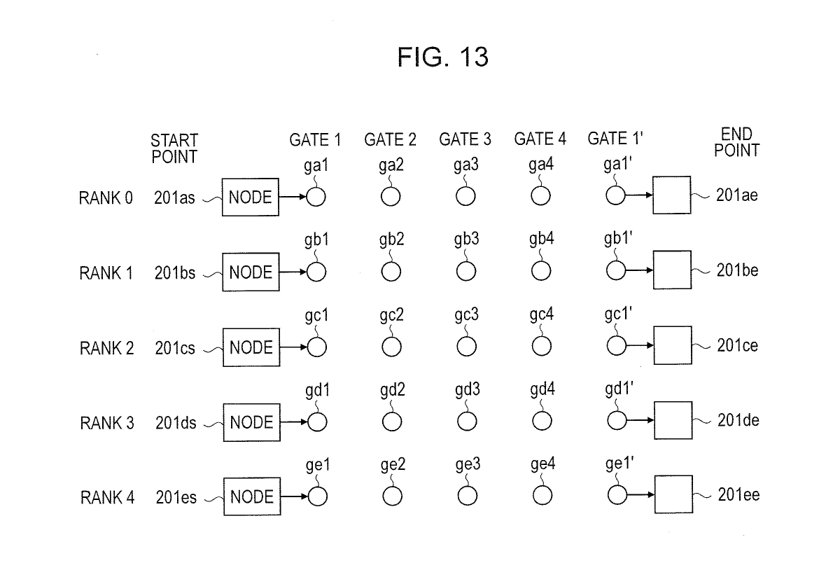

Accordingly, as illustrated in FIG. 13, the server 100 sets four gates (gates 1, 2, 3, and 4) and one dummy gate (gate 1′) in each node. Specifically, the server 100 sets gates ga1, ga2, ga3, ga4, and ga1′ in the node 201a. In the same way, the server 100 sets gates gb1, gb2, gb3, gb4, and gb1′ in the node 201b, sets gates gc1, gc2, gc3, gc4, and gc1′ in the node 201c, sets gates gd1, gd2, gd3, gd4, and gd1′ in the node 201d, and sets gates ge1, ge2, ge3, ge4, and ge1′ in the node 201e.

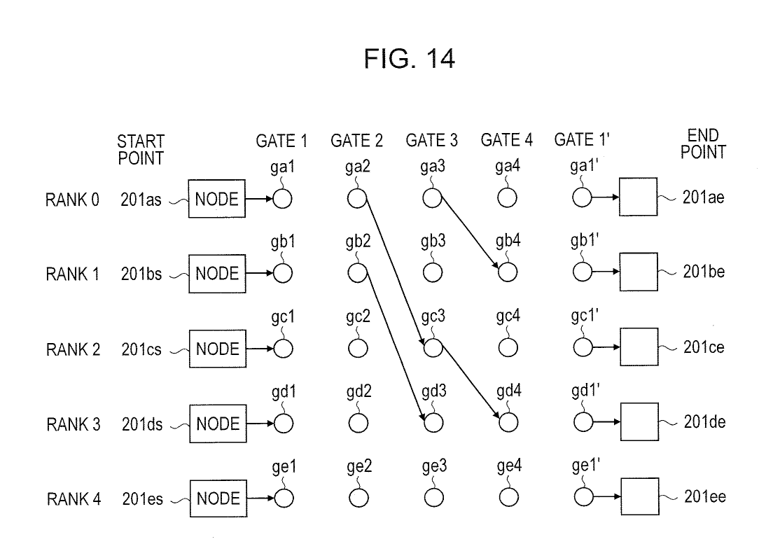

Next, the server 100 sets a path that establishes connection between individual gates and is a path of a direction in which a rank increases (a downward direction in FIG. 14). At this time, in the same way as when the number of ranks is a power of 2, the server 100 sets a path so that the length of the path located closer to the end point of each node becomes shorter (the number of transfer hops is small) and the length of the path located further away from the end point becomes longer (the number of transfer hops is large).

When the number of ranks is “5” as described above, as illustrated in FIG. 14, the server 100 set paths so that the lengths of the paths located (on a right side in FIG. 14) close to the end points 201ae to 201ee of the nodes 201a to 201e, respectively, become short and the lengths of the paths located (on a left side in FIG. 14) away from the end points 201ae to 201ee of the nodes 201a to 201e, respectively, become long.

As for the setting of a path of a direction in which a rank between gates increases, performed by the server 100, specifically, in paths leading from the gate 3 to the gate 4, a path is set that leads from the gate ga3 in the node 201a of the rank 0 to the gate gb4 in the node 201b of the rank 1 whose rank increases by “1”, the number of transfer hops of the path being “1”.

In addition, the server 100 sets a path that leads from the gate gc3 in the node 201c of the rank 2 to the gate gd4 in the node 201d of the rank 3 whose rank increases by “1”, the number of transfer hops of the path being “1”.

In addition, in paths leading from the gate 2 to the gate 3 and located away from the end points 201ae to 201ee compared with paths leading from the gate 3 to the gate 4, the server 100 sets a path that leads from the gate ga2 in the node 201a of the rank 0 to the gate gc3 in the node 201c of the rank 2 whose rank increases by “2”, the number of transfer hops of the path being “2”.

In addition, the server 100 sets a path that leads from the gate gb2 in the node 201b of the rank 1 to the gate gd3 in the node 201d of the rank 3 whose rank increases by “2”, the number of transfer hops of the path being “2”.

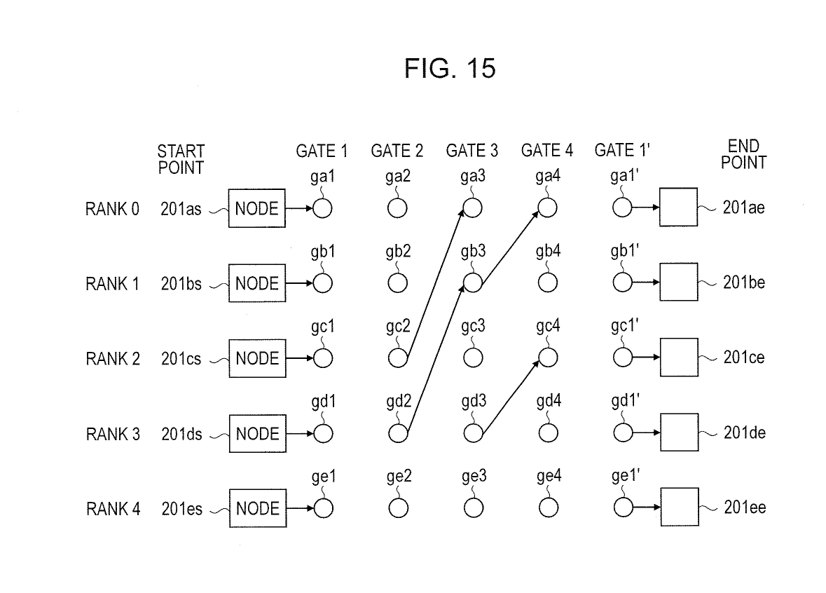

Next, the server 100 sets a path that establishes connection between individual gates and is a path of a direction in which a rank decreases (an upward direction in FIG. 15). At this time, in the same way as in FIG. 14, the server 100 sets a path so that the length of the path located closer to the end point of each node becomes shorter (the number of transfer hops is small) and the length of the path located further away from the end point becomes longer (the number of transfer hops is large).

As for the setting of a path of a direction in which a rank between gates decreases, performed by the server 100, specifically, in paths leading from the gate 3 to the gate 4, a path is set that leads from the gate gb3 in the node 201b of the rank 1 to the gate ga4 in the node 201a of the rank 0 whose rank decreases by “1”, the number of transfer hops of the path being “1”.

In addition, the server 100 sets a path that leads from the gate gd3 in the node 201d of the rank 3 to the gate gc4 in the node 201c of the rank 3 whose rank decreases by “1”, the number of transfer hops of the path being “1”.

In addition, in paths leading from the gate 2 to the gate 3 and located away from the end point 201ae to 201ee compared with paths leading from the gate 3 to the gate 4, the server 100 sets a path that leads from the gate gc2 in the node 201c of the rank 2 to the gate ga3 in the node 201a of the rank 0 whose rank decreases by “2”, the number of transfer hops of the path being “2”.

In addition, the server 100 sets a path that leads from the gate gd2 in the node 201d of the rank 3 to the gate gb3 in the node 201b of the rank 1 whose rank decreases by “2”, the number of transfer hops of the path being “2”.

Next, the server 100 sets a path coupled from a gate in a node in which the same path as when the above-mentioned number of ranks is a power of 2 is set to a final gate in the above-mentioned remaining node.

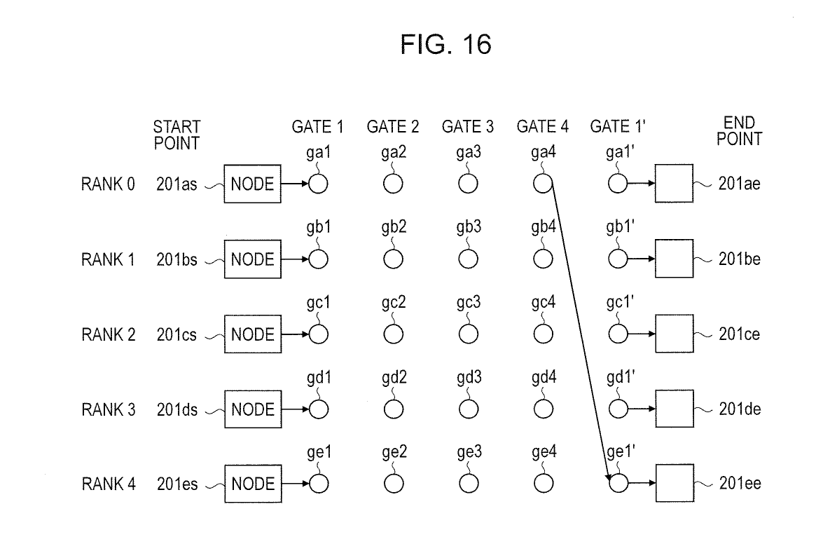

Specifically, as illustrated in FIG. 16, the server 100 sets a path that leads from the gate ga4 in the node 201a of the rank 0 to the gate ge1′ in the node 201e of the rank 4. Here, while a case in which the number of the remaining nodes is one is described in FIG. 16, a plurality of the remaining nodes may exist. In this case, the server 100 sets paths that couple final gates in the plural remaining nodes to gates in different nodes from among nodes in which paths are set.

Next, the server 100 sets a path coupled from an initial gate in the above-mentioned remaining node to a gate in a node in which the same path as when the above-mentioned number of ranks is a power of 2 is set.

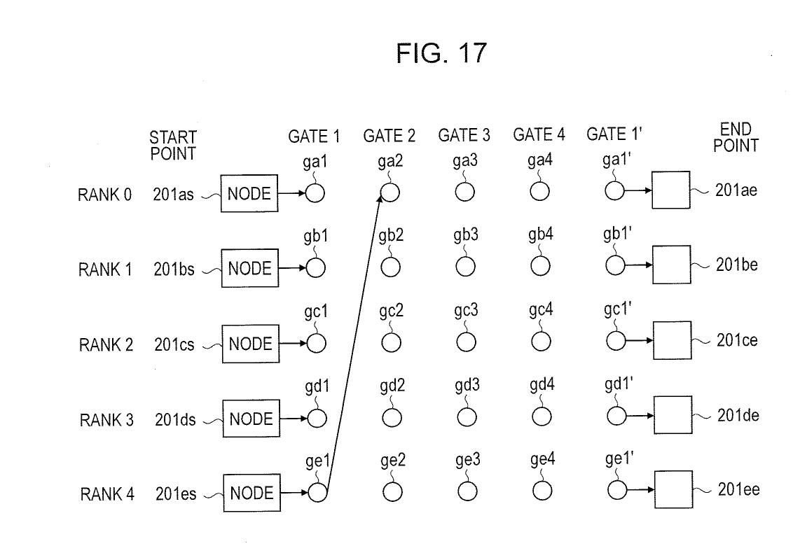

Specifically, as illustrated in FIG. 17, the server 100 sets a path leading from the gate ge1 in the node 201e of the rank 4 to the gate ga2 in the node 201a of the rank 0. Here, while a case in which the number of the remaining nodes is one is described in FIG. 17, in the same way as in FIG. 16, a plurality of the remaining nodes may exist. In this case, the server 100 sets paths that couple initial gates in the plural remaining nodes to gates in different nodes from among nodes in which paths are set.

Next, with respect to nodes whose number corresponds to Bmax that is a maximum power of 2 not exceeding the number of ranks, the server 100 sets a path coupling gates belonging to a same node to each other. Specifically, in the node 201a, the server 100 sets a path coupling the gate ga1 to the gate ga2, a path coupling the gate ga2 to the gate ga3, a path coupling the gate ga3 to the gate ga4, and a path coupling the gate ga4 to the gate ga1′.

In addition, in the node 201b, the server 100 sets a path coupling the gate gb1 to the gate gb2, a path coupling the gate gb2 to the gate gb3, a path coupling the gate gb3 to the gate gb4, and a path coupling the gate gb4 to the gate gb1′.

In addition, in the node 201c, the server 100 sets a path coupling the gate gc1 to the gate gc2, a path coupling the gate gc2 to the gate gc3, a path coupling the gate gc3 to the gate gc4, and a path coupling the gate gc4 to the gate gc1′.

In addition, in the node 201d, the server 100 sets a path coupling the gate gd1 to the gate gd2, a path coupling the gate gd2 to the gate gd3, a path coupling the gate gd3 to the gate gd4, and a path coupling the gate gd4 to the gate gd1′.

In addition, as for the node 201e of the rank 4, since the number of ranks (five ranks 0 to 4) exceeds Bmax=4 that is a maximum power of 2 not exceeding the above-mentioned number of ranks and paths have been already set in the nodes of ranks 0 to 4 whose number corresponding to Bmax, a network is not configured.

Accordingly, a path is not set that couples gates belonging to the node 201e of the rank 4 to each other.

In addition, in FIG. 18, all paths set by the server 100 are illustrated. As described above, in the present embodiment, when the number of ranks is not a power of 2, the server 100 sets the numbers of transfer hops to small values with respect to paths located close to the end points 201ae to 201ee, as for paths coupling gates in the nodes 201a to 201e.

In addition, the server 100 sets the numbers of transfer hops to large values with respect to paths located close to the start points 201as to 201es.

Accordingly, as for paths coupling gates in the nodes 201a to 201e, paths are set so that the lengths of the paths located closer to the end points 201ae to 201ee become shorter (the numbers of transfer hops are small) and the lengths of the paths located closer to the start points 201as to 201es become longer (the numbers of transfer hops are large).

In addition, as illustrated in FIG. 18, the gates ge2, ge3, and ge4 of the rank 4 (in the node 201e) do not configure a network, and the node 201e is not used for processing requested by the client device 300, in these stages. Namely, in the gates ge2, ge3, and ge4, the node 201e does not execute the processing of data and the transmission/reception of a processing result.

FIG. 19 to FIG. 21 illustrate a method of network configuration processing in the second embodiment. The server 100 of the present embodiment acquires the number of ranks that is the number of nodes included in the node system 200, and executes network configuration processing in which the configuration of the network of the node system 200 is set on the basis of the acquired number of ranks.

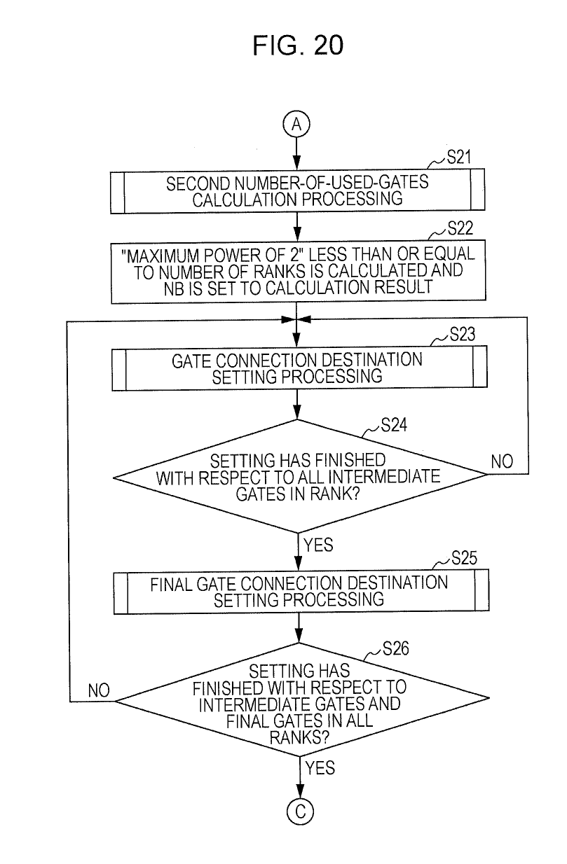

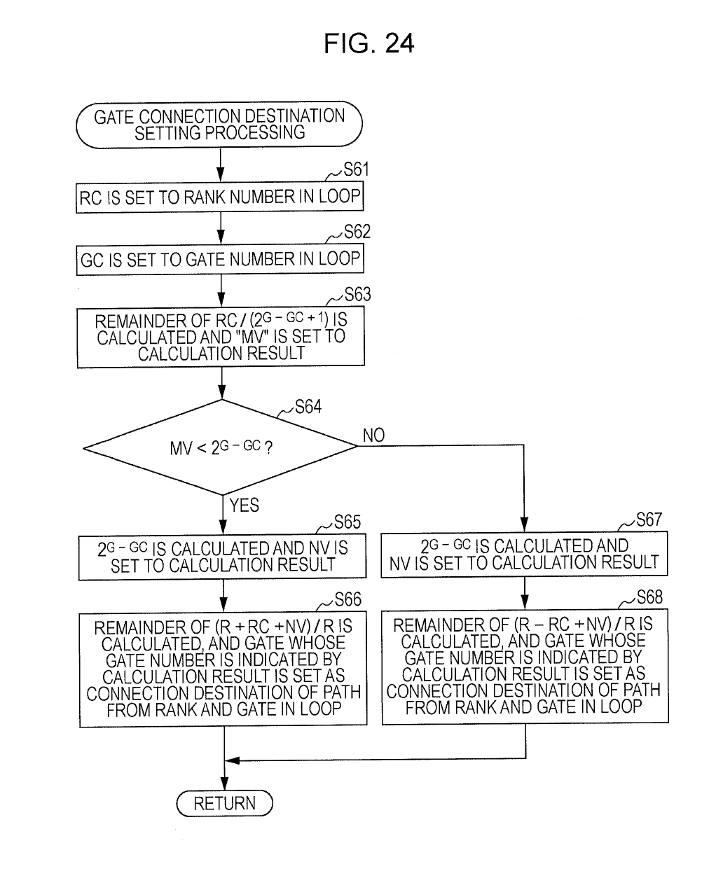

Hereinafter, the network configuration processing illustrated in FIG. 19 to FIG. 21 will be described along the step numbers of each method.

[Operation S11] The node manager 112 acquires the number of ranks input from the client device 300 owing to the operation of a user, and sets “R” to the acquired number of ranks. Accordingly, the number of ranks (namely, the number of nodes described above in FIG. 7 and FIG. 12) of the node system 200 is determined, and the determined number of nodes are set in the node system 200.

[Operation S12] The node manager 112 determines whether or not the number of ranks acquired in operation S11 is “a power of 2”. When the number of ranks is a power of 2 (operation S12: YES), the processing proceeds to operation S13. On the other hand, when the number of ranks is not a power of 2 (operation S12: NO), the processing proceeds to operation S21 (FIG. 20).

[Operation S13] The node manager 112 executes first number-of-used-gates calculation processing for calculating the number of used gates when the number of ranks is a power of 2. The first number-of-used-gates calculation processing will be described later in detail in FIG. 22. In addition, the node manager 112 sets gates whose number is equal to the number of used gates calculated in the first number-of-used-gates calculation processing. Accordingly, in the node system 200, the number of gates included in each node, described above in FIG. 8, is determined, and the determined number of gates and a dummy gate are set with respect to each gate.

[Operation S14] The node manager 112 executes gate connection destination setting processing so as to set paths coupling gates calculated and set in operation S13. The gate connection destination setting processing will be described later in detail in FIG. 24. In operation S14, first, the node manager 112 selects one arbitrary rank (node) in which the setting of a path has not finished yet, selects one arbitrary gate in the selected rank, in which the setting of a path has not finished yet, and executes gate connection destination setting processing with respect to the selected gate.

[Operation S15] The node manager 112 determines whether or not the gate connection destination setting processing has been executed with respect to the arbitrary rank selected in operation S14 and the setting of the connection destinations of paths has finished with respect to all gates in the arbitrary rank.

When the setting of the connection destinations of paths has finished with respect to all gates in the arbitrary rank (operation S15: YES), the processing proceeds to operation S16. On the other hand, when, from among the ranks of all gates, there is a rank in which the setting of the connection destination of a path has not finished (operation S15: NO), the processing proceeds to operation S14, and the gate connection destination setting processing is executed with respect to a gate in which the setting of the connection destination of a path has not finished in the rank selected in operation S14.

The loop due to operation S14 and operation S15 is repeated as many times as the number of used gates calculated in operation S13. For example, since, in the examples in FIG. 7 to FIG. 11, the calculation result of the number of used gates is “2”, and two gates of gates 1 and 2 are set in each node, the gate connection destination setting processing in operation S14 is repeated two times.

[Operation S16] The node manager 112 determines whether or not the gate connection destination setting processing has been executed with respect to gates of all ranks and the setting of the connection destinations of paths has finished with respect to all gates of all ranks.

When the setting of the connection destinations of paths has finished with respect to all gates of all ranks (operation S16: YES), the processing proceeds to operation S17. On the other hand, when, from among the ranks of all gates, there is a rank in which the setting of the connection destination of a path has not finished (operation S16: NO), the processing proceeds to operation S14, a subsequent arbitrary rank is selected, and the gate connection destination setting processing is executed with respect to each gate of the selected rank.

The loop due to operation S14, operation S15, and operation S16 is repeated as many times as the number of ranks acquired in operation S11. For example, since, in the examples of methods in FIG. 7 to FIG. 11, “4” is acquired as the number of ranks of the node system 200, and four nodes of ranks 0, 1, 2, and 3 are set, the loop from operation S14 to operation S16 is repeated four times.

[Operation S17] The node manager 112 sets paths whose connection destinations are a same node. Accordingly, paths of all processing operations in the node system 200 are set as described above in the methods in FIG. 11 and FIG. 18. After that, the processing finishes.

[Operation S21] The node manager 112 executes second number-of-used-gates calculation processing for calculating the number of used gates when the number of ranks is not a power of 2.

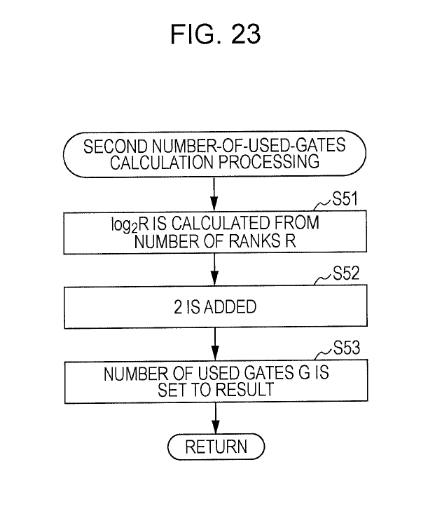

The second number-of-used-gates calculation processing will be described later in detail in FIG. 23. In addition, the node manager 112 sets gates whose number is equal to the number of used gates calculated in the second number-of-used-gates calculation processing.

Accordingly, in the node system 200, the number of gates included in each gate, described above in FIG. 13, is determined, and the determined number of gates and a dummy gate are set with respect to each gate.

[Operation S22] The node manager 112 calculates a maximum power of 2, Bmax, less than or equal to the number of ranks acquired in operation S11, and sets “NB” to the calculation result.

Here, for example, the NB may be calculated by defining the number of ranks as “R”, calculating log₂ R, truncating after the decimal point to obtain “N”, and calculating NB=2^{N}.

[Operation S23] The node manager 112 executes gate connection destination setting processing so as to set paths coupling intermediate gates from among gates calculated and set in operation S13. The intermediate gates are gates other than initial gates described above in FIG. 17 and final gates described above in FIG. 16, from among set gates.

In operation S23, first, the node manager 112 selects one arbitrary rank in which the setting of a path of an intermediate gate has not finished yet, selects one arbitrary intermediate gate in the selected rank, in which the setting of a path has not finished yet, and executes gate connection destination setting processing with respect to the selected intermediate gate.

[Operation S24] The node manager 112 determines whether or not the gate connection destination setting processing has been executed with respect to the arbitrary rank selected in operation S23 and the setting of the connection destinations of paths has finished with respect to all intermediate gates in the selected rank.

When the setting of the connection destinations of paths has finished with respect to all intermediate gates in the selected rank (operation S24: YES), the processing proceeds to operation S25.

On the other hand, when, from among all intermediate gates in the selected rank, there is an intermediate gate in which the setting of the connection destination of a path has not finished (operation S24: NO), the processing proceeds to operation S23, and the gate connection destination setting processing is executed with respect to an intermediate gate in which the setting of the connection destination of a path has not finished in the rank selected in operation S23.

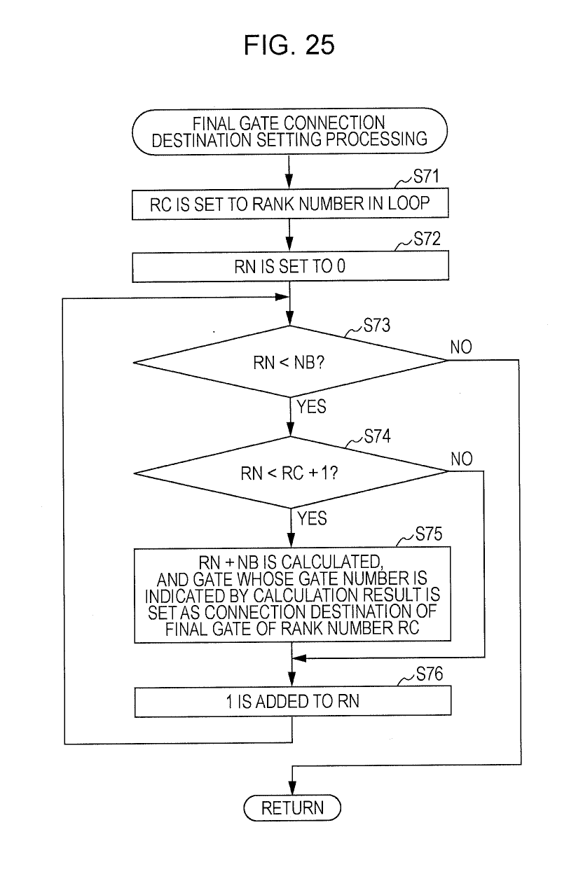

The loop due to operation S23 and operation S24 is repeated as many times as the number of used gates calculated in operation S13. For example, since, in the examples in FIG. 12 to FIG. 18, the calculation result of the number of used gates is “4”, and two gates of gates 2 and 3 are set in each node with excluding one initial gate and one final gate, the gate connection destination setting processing in operation S23 is repeated two times.

[Operation S25] The node manager 112 executes final gate connection destination setting processing so as to set a path coupling a final gate. The final gate connection destination setting processing will be described later in detail in FIG. 25. In operation S25, the node manager 112 executes the final gate connection destination setting processing with respect to a final gate in the rank selected in operation S24.

[Operation S26] The node manager 112 determines whether or not the gate connection destination setting processing has been executed with respect to intermediate gates and the final gate connection destination setting processing has been executed with respect to final gates, in all ranks, and the setting of the connection destinations of paths has finished with respect to all intermediate gates and final gates of all ranks.

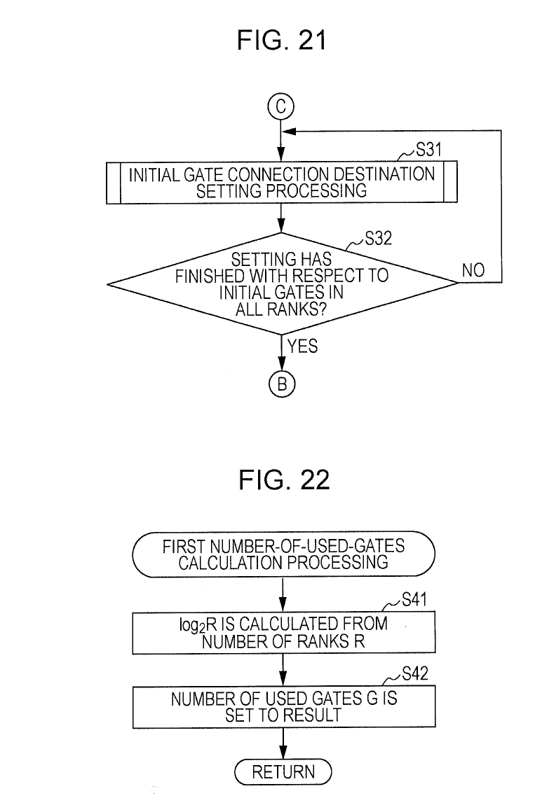

When the setting of the connection destinations of paths has finished with respect to all intermediate gates and final gates of all ranks (In operation S26: YES), the processing proceeds to operation S31 (FIG. 21). On the other hand, when, with respect to all intermediate gates and final gates, there is a rank in which the setting of the connection destination of a path has not finished (operation S26: NO), the processing proceeds to operation S23, a subsequent arbitrary rank is selected, the gate connection destination setting processing is executed with respect to each intermediate gate of the selected rank, and the final gate connection destination setting processing is executed with respect to a final gate.

[Operation S31] The node manager 112 executes initial gate connection destination setting processing so as to set a path coupling an initial gate.

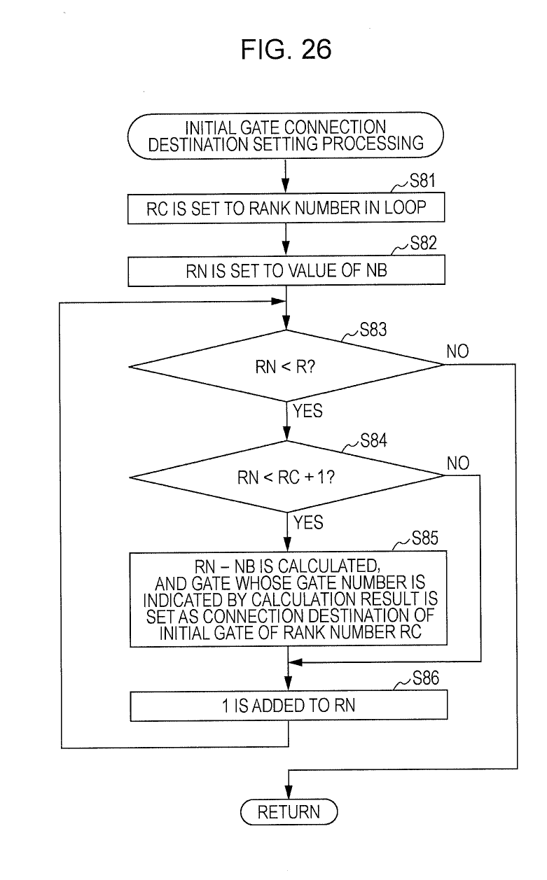

The initial gate connection destination setting processing will be described later in detail in FIG. 26. In operation S31, the node manager 112 selects one arbitrary rank in which the setting of a path of an initial gate has not finished yet, and executes initial gate connection destination setting processing with respect to the initial gate of the selected rank.

[Operation S32] The node manager 112 determines whether or not the initial gate connection destination setting processing has been executed with respect to initial gates of all ranks and the setting of the connection destinations of paths has finished with respect to initial gates of all ranks.

When the setting of the connection destinations of paths has finished with respect to initial gates of all ranks (operation S32: YES), the processing finishes. On the other hand, when there is a rank in which the setting of the connection destination of a path has not finished with respect to an initial gate (operation S32: NO), the processing proceeds to operation S31, and a subsequent arbitrary rank is selected from among ranks in each of which the setting of the connection destination of a path has not finished with respect to an initial gate.

Next, the initial gate connection destination setting processing is executed with respect to the initial gate of the selected rank.

FIG. 22 illustrates a method of the first number-of-used-gates calculation processing in the second embodiment.

When the number of ranks acquired in the network configuration processing is a power of 2, the server 100 of the present embodiment executes the first number-of-used-gates calculation processing for calculating the number of used gates on the basis of the acquired number of ranks that is a power of 2 and setting the number of used gates.

Hereinafter, the first number-of-used-gates calculation processing illustrated in FIG. 22 will be described along the step numbers of the method.

[Operation S41] The node manager 112 calculates a binary logarithm (log₂ R) of the number of ranks R acquired in operation S11 of the network configuration processing.

[Operation S42] The node manager 112 sets the number of used gates, “G”, to the calculation result of operation S41. After that, the processing returns.

FIG. 23 illustrates the second number-of-used-gates calculation processing in the second embodiment. When the number of ranks acquired in the network configuration processing is not a power of 2, the server 100 of the present embodiment executes the second number-of-used-gates calculation processing for calculating the number of used gates on the basis of the acquired number of ranks that is not a power of 2 and setting the number of used gates. Hereinafter, the second number-of-used-gates calculation processing illustrated in FIG. 23 will be described along the step numbers of the method.

[Operation S51] In the same way as in operation S22 in the network configuration processing, the node manager 112 calculates a binary logarithm (log₂ R) of the number of ranks R acquired in operation S11 of the network configuration processing, and calculates “N” that is a result obtained by truncating after the decimal point.

[Operation S52] The node manager 112 adds “2” to the calculation result N of operation S51.

When the number of ranks is not a power of 2, as illustrated in FIG. 16 and FIG. 17, it is necessary to set a path coupling the above-mentioned remaining node to a node in which the same path as when the number of ranks is a power of 2 is set.

Therefore, when the number of ranks is not a power of 2, the initial gate and the final gate of the above-mentioned remaining node are necessary in addition to gates in a case in which the number of ranks is a power of 2. On the basis of this, when the number of ranks is not a power of 2, the number of used gates is increased by “2” compared with a case in which the number of ranks is a power of 2 in operation S51.

[Operation S53] The node manager 112 sets the number of used gates “G” to the calculation result N in operation S52. After that, the processing returns.

FIG. 24 illustrates a method of the gate connection destination setting processing in the second embodiment. The server 100 of the present embodiment executes the gate connection destination setting processing for setting a connection destination due to a path of a gate set in the network configuration processing.

In the gate connection destination setting processing, when the number of ranks is a power of 2, the connection destinations of all gates are set, and when the number of ranks is not a power of 2, the connection destination of an intermediate gate other than an initial gate and a final gate is set. Hereinafter, the gate connection destination setting processing illustrated in FIG. 24 will be described along the step numbers of the method.

[Operation S61] The node manager 112 sets “RC” to a rank number indicating the rank of the target of processing at the time of the loop from operation S14 to operation S16 or the loop from operation S23 to operation S26 in the network configuration processing.

[Operation S62] The node manager 112 sets “GC” to a gate number indicating the gate of the target of processing at the time of the loop from operation S14 to operation S15 or the loop from operation S23 to operation S24 in the network configuration processing.

[Operation S63] The node manager 112 calculates the remainder of RC/(2^{G-GC+1}) and sets “MV” to the calculation result.

[Operation S64] The node manager 112 determines whether or not MV<2^{G-GC} is satisfied. When MV<2^{G-GC} is satisfied (operation S64: YES), the processing proceeds to operation S65. On the other hand, when MV≧2^{G-GC} is satisfied (operation S64: NO), the processing proceeds to operation S67.

[Operation S65] The node manager 112 calculates 2^{G-GC}, and sets “NV” to the calculation result.

[Operation S66] The node manager 112 calculates the remainder of (R+RC+NV)/R, and sets a gate whose gate number is indicated by the calculation result as the connection destination of a path from the rank number RC and the gate number GC in a current loop. Accordingly, a path of a direction in which a rank increases (downward directions in FIG. 9 and FIG. 14), described above in FIG. 9 and FIG. 14, is set in the node system 200.

[Operation S67] The node manager 112 calculates 2^{G-GC}, and sets “NV” to the calculation result.

[Operation S68] The node manager 112 calculates the remainder of (R−RC+NV)/R, and sets a gate whose gate number is indicated by the calculation result as the connection destination of a path from the rank number RC and the gate number GC in a current loop. Accordingly, a path of a direction in which a rank decreases (upward directions in FIG. 10 and FIG. 15), described above in FIG. 10 and FIG. 15, is set in the node system 200.

FIG. 25 illustrates a method of the final gate connection destination setting processing in the second embodiment. The server 100 of the present embodiment executes the final gate connection destination setting processing for setting a connection destination due to a final path on a side located closest to the end point of a gate set in the network configuration processing when the number of ranks is not a power of 2. Hereinafter, the final gate connection destination setting processing illustrated in FIG. 25 will be described along the step numbers of the method.

[Operation S71] The node manager 112 sets “RC” to a rank number indicating the rank of the target of processing at the time of the loop from operation S23 to operation S26 in the network configuration processing.

[Operation S72] The node manager 112 sets “RN” to an initial value “0”.

[Operation S73] The node manager 112 determines whether or not RN<NB is satisfied. When RN<NB is satisfied (operation S73: YES), the processing proceeds to operation S74. On the other hand, when RN≧NB is satisfied (operation S73: NO), the processing returns.

[Operation S74] The node manager 112 determines whether or not RN<RC+1 is satisfied. When RN<RC+1 is satisfied (operation S74: YES), the processing proceeds to operation S75. On the other hand, when RN≧RC+1 is satisfied (operation S74: NO), the processing proceeds to operation S76.

[Operation S75] The node manager 112 calculates RN+NB, and sets a gate whose gate number is indicated by the calculation result as the connection destination of a final gate of the rank number RC. Namely, a path coupling a final gate in the remaining node, described above in FIG. 16, to another gate is set in the node system 200. Accordingly, a final gate in the node of a rank exceeding a maximum power of 2 not exceeding the number of ranks is coupled to the gate of a rank less than or equal to the maximum power of 2 not exceeding the number of ranks.

[Operation S76] The node manager 112 adds “1” to the RN. After that, the processing proceeds to operation S73.

FIG. 26 illustrates a method of the initial gate connection destination setting processing in the second embodiment. The server 100 of the present embodiment executes the initial gate connection destination setting processing for setting a connection destination due to an initial path on a side located closest to the start point of a gate set in the network configuration processing when the number of ranks is not a power of 2. Hereinafter, the initial gate connection destination setting processing illustrated in FIG. 26 will be described along the step numbers of the method.

[Operation S81] The node manager 112 sets “RC” to a rank number indicating the rank of the target of processing at the time of the loop from operation S23 to operation S26 in the network configuration processing.

[Operation S82] The node manager 112 sets “RN” to the value of the NB.

[Operation S83] The node manager 112 determines whether or not RN<R is satisfied. When RN<R is satisfied (operation S83: YES), the processing proceeds to operation S84. On the other hand, when RN≧R is satisfied (operation S83: NO), the processing returns.

[Operation S84] The node manager 112 determines whether or not RN<RC+1 is satisfied. When RN<RC+1 is satisfied (operation S84: YES), the processing proceeds to operation S85. On the other hand, when RN≧RC+1 (operation S84: NO), the processing proceeds to operation S86.

[Operation S85] The node manager 112 calculates RN−NB, and sets a gate whose gate number is indicated by the calculation result as the connection destination of an initial gate of the rank number RC. Namely, a path coupling an initial gate described above in FIG. 16 is set in the node system 200. Accordingly, an initial gate in the node of a rank exceeding a maximum power of 2 not exceeding the number of ranks is coupled to the gate of a rank less than or equal to the maximum power of 2 not exceeding the number of ranks.

[Operation S86] The node manager 112 adds “1” to the RN. After that, the processing proceeds to operation S83.

In such a way as described above, in the server 100 of the second embodiment, with respect to the configuration of the network of the node system 200, a path located close to the end point, through which a large amount of data tends to flow, is set to become shorter than other paths, thereby reducing the transfer amount of data within the network of the node system 200. Accordingly, by making the transfer of data within a network efficient to reduce a communication amount, it is possible to suppress the occurrence of communication congestion and the occurrence of the loss of processing calculation time.

In addition, the length of a path that is located closer to the end point and through which a relatively large amount of data tends to flow is set to a shorter length (the number of transfer hops is small), and the length of a path that is located further away from the end point and through which a relatively small amount of data tends to flow is set to a longer length (the number of transfer hops is large).

Therefore, the transfer amount of data in the entire network of the node system 200 is caused to be reduced. Accordingly, by making the transfer of data within a network more efficient to reduce a communication amount, it is possible to suppress the occurrence of communication congestion and the occurrence of the loss of processing calculation time.

In addition, the length of a path between nodes is defined using the number of transfer hops, and hence it is possible to simplify processing at the time of the setting of a path. In addition to this, in particular, it is also possible to suppress the increase of a burden at the time of configuring a network in which the number of nodes is large.

In addition, processing executed in each node in the node system 200 is divided into processing operations of a plurality of stages, and individual nodes are coupled through paths, thereby configuring the network. Accordingly, the node manager 112 sets paths in such a way as described above, thereby reducing the transfer amount of data processed and transmitted/received between nodes.

Therefore, by making the transfer of data within the network efficient to reduce a communication amount, it is possible to suppress the occurrence of communication congestion and the occurrence of the loss of processing calculation time.

In addition, in the node system 200, with respect to each of processing operations of divided stages, the processing is advanced with the completion of processing in another node being waited for on the basis of the barrier synchronization. Therefore, in many cases, data processed in each node is simultaneously transferred to another node.

On the other hand, the node manager 112 sets paths in such a way as described above, thereby reducing the transfer amount of data processed and transmitted/received between nodes. Therefore, by making the transfer of data within the network efficient to reduce a communication amount, it is possible to suppress the occurrence of communication congestion and the occurrence of the loss of processing calculation time.

In addition, in the node system 200, the processing is advanced using paths through which individual nodes are recursively coupled. Therefore, in many cases, data processed in each node is simultaneously transferred to another node. On the other hand, the node manager 112 sets paths in such a way as described above, thereby reducing the transfer amount of data processed and transmitted/received between nodes.

Therefore, by making the transfer of data within the network efficient to reduce a communication amount, it is possible to suppress the occurrence of communication congestion and the occurrence of the loss of processing calculation time.

In addition, the above-mentioned processing function may be realized using a computer. In this case, there is provided a program in which the content of the processing of a function to be included in the server 100 is described. By causing the computer to execute the program, the above-mentioned processing function is realized on the computer. The program describing therein the content of the processing may be recorded in a computer readable recording medium.

Examples of the computer readable recording medium include a magnetic storage device, an optical disk, a magneto-optical recording medium, and a semiconductor memory. Examples of the magnetic storage device include a hard disk drive (HDD), a flexible disk (FD), and a magnetic tape. Examples of the optical disk include a DVD, a DVD-RAM, and a CD-ROM/RW. Examples of the magneto-optical recording medium include a magneto-optical disk (MO).

When the program is distributed, portable recording media in which the program is recorded, such as DVDs, CD-ROMs, and the like, are marketed, for example. In addition, the program may be stored in a storage device in a server computer, and the program may be transferred from the server computer to another computer through a network.

A computer executing the program stores the program recorded in a portable recording medium or the program transferred from the server computer in a self-storage device, for example. In addition, the computer reads out the program from the self-storage device, and executes processing in accordance with the program.

In addition, the computer may also directly read out the program from the portable recording medium and execute processing in accordance with the program. In addition, every time the program is transferred from the server computer coupled through the network, the computer may also sequentially execute processing in accordance with the received program.

In addition, at least part of the above-mentioned processing function may also be realized using an electronic circuit such as a digital signal processor (DSP), an application specific integrated circuit (ASIC), a programmable logic device (PLD), or the like.

While, as above, the disclosed computing system, the disclosed configuration management device, and the disclosed configuration manager have been described on the basis of the illustrated embodiments, the configuration of each unit may be replaced with an arbitrary configuration having the same function.

In addition, another arbitrary structure or another arbitrary process may also be added to the disclosed technology. In addition, the disclosed technology may also be the combination of two or more arbitrary configurations from among the above-mentioned embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions has(have) been described in detail, it should be understood that the various changes, substitutions, and alterations could be made hereto without departing from the spirit and scope of the invention.

What is claimed is:

1. A computing system comprising:
a node system configured to include each of a plurality of nodes coupled through paths processes received data and transmits data of a processing result to another node; and
a configuration manager configured to include a node manager setting a first length of a path located dose to an end point from which data is output in the node system to a second length grater than or equal to the first length, of a path located further away from the end point when paths coupling the nodes to one another are set, the node system processing data by using a network in which the plurality of nodes are coupled through paths set by the node manager.

2. The computing system according to claim 1, wherein
the node manager sets the length of a path located closer to the end point to a shorter length, and sets the length of a path located further away from the end point to a longer length.

3. The computing system according to claim 1, wherein
the length of the path is defined using the number of transfer hops.

4. The computing system according to claim 1, wherein
in the node system, processing executed in each node is divided into processing operations of a plurality of stages.

5. The computing system according to claim 4, wherein
the node system waits for the completion of processing in another node with respect to each of the processing operations of the divided stages.

6. The computing system according to claim 1, wherein
in the node system, each of the nodes is recursively coupled through a path in the network of the path.

7. The computing system according to claim 1, wherein
in the node system, the network of paths is a three-dimensional torus.

8. The computing system according to claim 1, wherein
in the node system, the network of paths is a fat tree.

9. A configuration management method comprising:
setting paths of a node system in which each of a plurality of nodes coupled through paths processes received data and transmits data of a processing result to another node; and
setting a first length of a path located close to an end point from which data is output in the node system to a second length greater than or equal to the first length, of a path located further away from the end point when paths coupling the nodes to one another are set.
